(19) United States
(12) Patent Application Publication
(10) Pub. No.: US 2025/0147707 A1
(43) Pub. Date: May 8, 2025

(54) STORAGE MEDIUM, CONTROL METHOD OF INFORMATION PROCESSING APPARATUS, AND INFORMATION PROCESSING APPARATUS

(71) Applicant: CANON KABUSHIKI KAISHA, Tokyo (JP)

(72) Inventor: DAICHI HIDAKA, Tokyo (JP)

(21) Appl. No.: 18/936,817

(22) Filed: Nov. 4, 2024

(30) Foreign Application Priority Data
Nov. 7, 2023 (JP) 2023-189827

(51) Int. Cl. G06F 3/12

(52) U.S. Cl. CPC G06F 3/126; G06F 3/1206; G06F 3/1287

(57) ABSTRACT

A non-transitory computer-readable storage medium stores an application program which causes an information processing apparatus to perform a control method. The information processing apparatus has printing software. The control method includes receiving an image processing setting, storing data to which image processing corresponding to the image processing setting is applied into a predetermined storage area of the information processing apparatus in response to acceptance of an instruction to perform processing in a state where a virtual printer for which data is set to be generated using the printing software is selected, and transmitting the data to which the image processing corresponding to the image processing setting is applied to a physical printer for which data is set to be generated using the printing software in response to acceptance of an instruction to perform processing in a state where the physical printer is selected as a printing destination.

### BACKGROUND

### Field of the Disclosure

The present disclosure relates to a storage medium, a control method of an information processing apparatus, and an information processing apparatus.

### Description of the Related Art

A configuration where a printer driver installed on a host computer as control software of a printing apparatus is used to issue print instructions to the printing apparatus connected to the host computer has been known. An operating system (OS) that is basic software is installed on the host computer. The printer driver is configured according to specifications defined by the OS, and operates when called by the OS. Vendors (manufacturers) providing printing apparatuses can provide a mechanism for issuing print instructions to the printing apparatuses using the OS by providing printer drivers compliant with the OS specifications.

Windows (registered trademark) has recently been providing standard class drivers (hereinafter, also referred to as “generic printer drivers”) that can be used in common across printing apparatuses provided by a plurality of vendors. Such a standard driver is bundled in the OS package, and can be easily used by connecting a printing apparatus to the host computer. This conveniently eliminates the need to install a model-specific printer driver suited to the printing apparatus separately. The standard driver is configured so that print functions can be specified using Print Device Capabilities (PDC) generated based on information acquired from the connected printing apparatus. The user who uses the standard driver can thus specify print functions depending on the capabilities of connected printing apparatuses despite using a single standard driver.

The standard driver can be associated with a function extension application (hereinafter, also referred to as an “extension application”). The extension application can be provided by vendors providing printing apparatuses. The extension application can provide functions (extended functions) that are unable to be implemented by the standard driver alone, by editing the PDC generated by the standard driver. The editing of the PDC refers to modification or deletion of existing print functions in the PDC generated by the standard driver, or addition of new print functions.

Japanese Patent Application Laid-Open No. 2021-108001 discusses a technique for extending the functions of a standard driver by editing PDC using an extension application, based on information acquired from the printer.

Some applications handle print data generated using a virtual queue (also referred to as a virtual printer) that is a print queue not connected to any actual printing apparatus or print server. For example, such applications perform processing for laying out drawing data included in a plurality of pieces of print data generated using a virtual queue on a single sheet.

Generic printer drivers acquire information about the functions of an actual printing apparatus (physical printer) from the printing apparatus and generate a print queue. Generic printer drivers are therefore not expected to be used with an application that does not communicate with an actual printing apparatus as described above.

### SUMMARY

Embodiments of the present disclosure are directed to using a generic printer driver without any actual printing apparatus connected.

According to an embodiment of the present disclosure, a non-transitory computer-readable storage medium storing an application program which causes an information processing apparatus to perform a control method, the information processing apparatus having printing software, the control method including receiving an image processing setting, storing data to which image processing corresponding to the image processing setting is applied into a predetermined storage area of the information processing apparatus in response to acceptance of an instruction to perform processing in a state where a virtual printer for which data is set to be generated using the printing software is selected, and transmitting the data to which the image processing corresponding to the image processing setting is applied to a physical printer for which data is set to be generated using the printing software in response to acceptance of an instruction to perform processing in a state where the physical printer is selected as a printing destination, wherein the printing software is configured to output data printable by a plurality of printing apparatuses of a plurality of different manufacturers to one printing apparatus based on an Internet Printing Protocol (IPP), the one printing apparatus being selected by a user from the plurality of printing apparatuses.

Further features of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of a printing system according to a first exemplary embodiment.

FIGS. 2A and 2B are diagrams illustrating examples of a software configuration of the printing system according to the first exemplary embodiment.

FIG. 3 is a diagram illustrating an example of Print Device Capabilities (PDC) generated by print data generation software according to the first exemplary embodiment.

FIG. 4 is a diagram illustrating an example of the PDC edited by a print function extension unit according to the first exemplary embodiment.

FIGS. 5A, 5B, and 5C are diagrams illustrating examples of a print setting screen provided by a print setting screen extension unit according to the first exemplary embodiment.

FIG. 6 is a diagram illustrating an example of a sequence in installing an application according to the first exemplary embodiment.

FIGS. 7A and 7B are diagrams illustrating an example of a sequence during data output to the application and printing according to the first exemplary embodiment.

FIG. 8 is a diagram illustrating an example of a print setting screen of a drawing application according to the first exemplary embodiment.

FIG. 9 is a diagram illustrating an example of a print setting screen of the application according to the first exemplary embodiment.

FIG. 10 is a diagram illustrating an example of a sequence in installing an application according to a second exemplary embodiment.

FIGS. 11A and 11B are diagrams illustrating an example of a sequence during data output to the application and printing according to the second exemplary embodiment.

FIGS. 12A and 12B are diagrams illustrating an example of a sequence during data output to an application and printing according to a third exemplary embodiment.

FIG. 13 is a diagram illustrating an example of information that a printing apparatus returns as a response to Get-Printer-Attributes according to the first exemplary embodiment.

FIGS. 14A and 14B are diagrams illustrating an example of PrintCapabilities generated based on PDC according to the first exemplary embodiment.

FIG. 15 is a diagram illustrating an example of information for the application to instruct an operating system (OS) on capability information about a virtual queue according to the first exemplary embodiment.

FIG. 16 is a diagram illustrating an example of the PDC edited by the print function extension unit according to the first exemplary embodiment.

FIG. 17 is a diagram illustrating an example of PrintCapabilities generated based on PDC according to the first exemplary embodiment.

FIG. 18 is a diagram illustrating an example of PDC edited by a print function extension unit according to the second exemplary embodiment.

FIG. 19 is a flowchart illustrating an example of processing performed by the application according to the first exemplary embodiment.

FIG. 20 is a flowchart illustrating an example of processing performed by an extension application according to the first exemplary embodiment.

FIG. 21 is a flowchart illustrating an example of processing performed by an extension application according to the second exemplary embodiment.

FIG. 22 is a flowchart illustrating an example of processing performed when the extension application generates print data according to the second exemplary embodiment.

FIG. 23 is a diagram illustrating an example of a command issued by the application according to the first exemplary embodiment.

### DESCRIPTION OF THE EMBODIMENTS

Exemplary embodiments of the present disclosure will be described in detail below with reference to the attached drawings. The following exemplary embodiments are not intended to limit the present disclosure, and all combinations of features described in the exemplary embodiments are not necessarily essential to the solving means of the present disclosure.

Similar components are denoted by the same reference numerals. A description thereof will be omitted.

### Hardware Configuration of Printing System

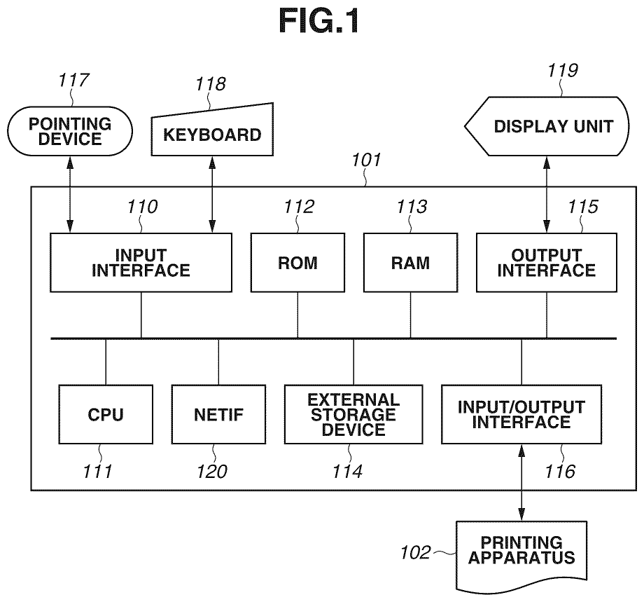

FIG. 1 is a block diagram illustrating a hardware configuration of a printing system according to a first exemplary embodiment. In this diagram, a host computer 101 is an example of an information processing apparatus, and includes an input interface 110, a central processing unit (CPU) 111, a read-only memory (ROM) 112, a random access memory (RAM) 113, an external storage device 114, an output interface 115, and an input/output interface 116. Input devices such as a keyboard 118 and a pointing device 117 are connected to the input interface 110. A display device such as a display unit 119 is connected to the output interface 115. A network interface (NETIF) 120 controls data transfer to/from external devices via a network.

The ROM 112 stores an initialization program. The external storage device 114 stores a group of application programs, an operating system (OS), print data generation software, and other various types of data. The RAM 113 is used as a work memory in executing various programs stored in the external storage device 114, whereby various programs can operate inside the host computer 101.

In the present exemplary embodiment, the functions of the host computer 101 to be described below and processing related to flowcharts to be described below are performed by the CPU 111 executing processing based on procedures of programs stored in the ROM 112. A printing apparatus 102 that is a device is connected to the host computer 101 via the input/output interface 116. In the present exemplary embodiment, the printing apparatus 102 will be described by using an inkjet printer that prints by discharging ink to a sheet as an example. However, the printing apparatus 102 may be a printing apparatus that prints by other methods (for example, electrophotographic printing). The host computer 101 may be a desktop personal computer, a smartphone, or a laptop personal computer.

In the present exemplary embodiment, an inkjet printer with a local connection will be described as an example of the type of printing apparatus 102. The printing apparatus 102 may be a laser beam printer (with a local connection or cloud connection), for example. The printing apparatus 102 is not limited to the foregoing two types, and may be of other device types or configured to determine connection modes. The local connection refers to a mode where the host computer 101 and the printing apparatus 102 are connected in a state capable of direct communication via the input/output interface 116 or the NETIF 120. The cloud connection refers to a connection mode where the host computer 101 issues print instructions to the printing apparatus 102 via the NETIF 120 and a not-illustrated cloud print service on the Internet. In the drawings to be described below, a printing apparatus illustrated with specific examples of features and options is an example of the printing apparatus of which the device type is an inkjet, unless otherwise specified.

### Software-Centered Configuration of Printing System

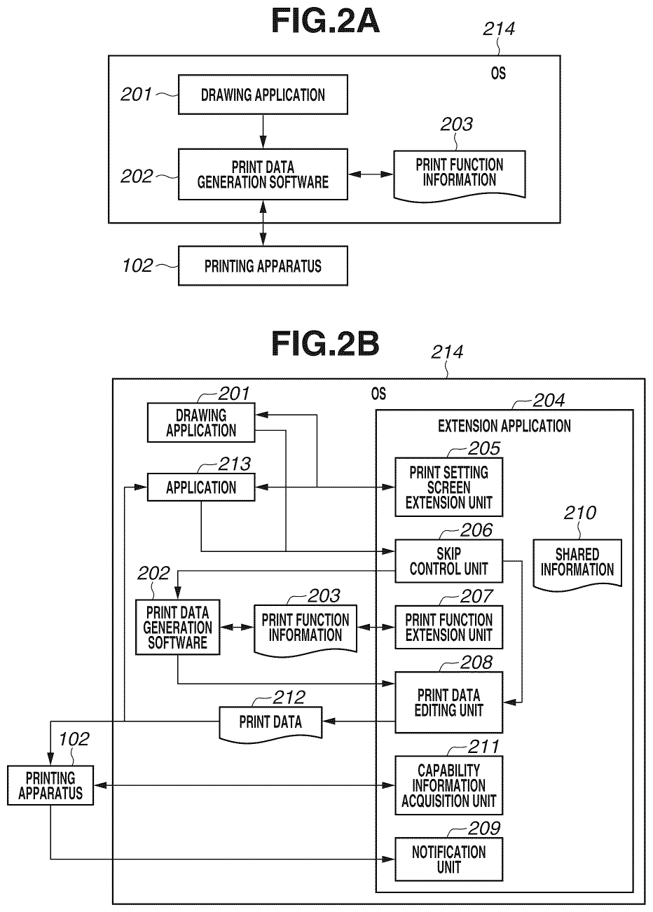

FIGS. 2A and 2B are diagrams schematically illustrating a software configuration of the printing system. The following description will be given on the assumption that the printing system uses a host computer 101 equipped with Microsoft (registered trademark) Windows (registered trademark) 11 as an OS 214. The configuration uses the Internet Printing Protocol (IPP) Class Driver included in the Windows (registered trademark) 11 as print data generation software 202. The IPP Class Driver is a printer driver that performs print processing in compliance with the specifications of a standard print protocol called IPP, and is bundled in the OS package. The IPP Class Driver is not a proprietary printer driver for the model of the printing apparatus 102, but a standard class driver that can be used in common by a plurality of models of printing apparatuses from a plurality of printer vendors (manufacturers). The IPP Class Driver is provided by the vendor (manufacturer, or supplier) that provides the OS 214. FIG. 2A is a diagram illustrating a typical configuration where an extension application 204 is not associated with the print data generation software 202 or the printing apparatus 102.

The drawing application 201 is software that generates contents to be printed (drawing data). Examples of the drawing application 201 include a word processing application and a spreadsheet application. When receiving a print request from the user, the drawing application 201 issues a print instruction to the OS 214. The print instruction includes print setting information for instructing the operation of the print data generation software 202 and the printing apparatus 102. The print setting information is also referred to as PrintTicket (PT).

To output the print setting information, the drawing application 201 can display a print setting screen provided by one of the print data generation software 202, the OS 214, and the drawing application 201. The print setting screen includes setting items (hereinafter, also referred to as “control items”) representing settable print functions and control items indicating the setting values of these functions based on capability information (information settable as print settings) acquired from the print data generation software 202. The capability information is also referred to as PrintCapabilities (PC). The print data generation software 202 determines the PC based on print function information 203. The print function information 203 is data indicating all settable print functions, setting values thereof, and an exclusive relationship with each setting value. The print function information 203 is also referred to as Print Device Capabilities (PDC) 203. The PDC 203 is included in a configuration file of the print data generation software 202, and dynamically generated by the print data generation software 202. Specifically, the print data generation software 202 or the OS 214 can be configured to acquire attribute data on the printing apparatus 102 from the printing apparatus 102 and generate the PDC 203 based on attribute information in the acquired attribute data. The attribute data on the printing apparatus 102 acquired from the printing apparatus 102 refers to a response acquired by issuing an IPP Get-Printer-Attributes operation to the printing apparatus 102. The response includes the attribute information (features) indicating functions that can be specified for the printing apparatus 102 (capabilities of the printing apparatus 102), and setting values (options) related to the attribute information. The response is stored in the RAM 113.

The print data generation software 202 can thus be configured so that the user can specify print functions usable in each printing apparatus 102, depending on the printing apparatus 102 connected. In other words, the print data generation software 202 can be configured so that even if printing apparatuses with different functions or printing apparatuses developed by different vendors are connected, the user can specify usable print functions depending on the connected printing apparatuses.

The OS 214 generates intermediate print data (also referred to as input data) based on the print instruction output from the drawing application 201, and passes the intermediate print data to the print data generation software 202. The data that the drawing application 201 outputs for printing purposes is data in Graphic Device Interface (GDI) format or data in Extensible Markup Language (XML) Paper Specification (XPS) format. If the IPP Class Driver is used as the print data generation software 202, the OS 214 converts the data in GDI format output from the drawing application 201 into data in XPS format. The OS 214 then passes the converted data in XPS format to the print data generation software 202 as the intermediate print data. If the data output from the drawing application 201 is data in XPS format, the OS 214 passes the data in XPS format to the print data generation software 202 as the intermediate print data. The intermediate print data includes the drawing data that is information about the image to be formed on a sheet, and the print setting information set by the user.

The print data generation software 202 converts the acquired intermediate print data into print data interpretable by the printing apparatus 102, and transmits the print data to the printing apparatus 102. The print data includes the drawing data that is the information about the image to be formed on a sheet, and print setting attribute information (attribute information for specifying print settings) generated based on the print setting information set by the user. The print setting attribute information includes the attribute information (features) indicating the functions that can be specified for the printing apparatus 102 (capabilities of the printing apparatus 102) and the setting values (options) related to the attribute information.

The printing apparatus 102 prints on a recording medium such as a sheet of paper based on the print data transmitted from the print data generation software 202. Here, the printing apparatus 102 forms the drawing data included in the print data on the recording medium such as a sheet of paper by operating based on the print setting attribute information included in the print data. The print setting attribute information includes attribute information for specifying print quality (such as image quality priority and speed priority) and two-sided printing, and setting values thereof. For example, if the print setting attribute information includes attribute information for specifying two-sided printing and a setting value indicating its activation, the printing apparatus 102 performs two-sided printing.

FIG. 2B is a diagram illustrating a configuration where the extension application 204 is associated with the print data generation software 202 and the printing apparatus 102. Components and processes not mentioned in particular below are similar to those in FIG. 2A.

The extension application 204 is software for extending the functions of the print data generation software 202, and executed on the OS 214. The extension application 204 is not included in (bundled with) the OS 214 in advance. The user therefore desirably downloads the extension application 204 from a server via the Internet and install the extension application 204 by operating the host computer 101. Alternatively, the extension application 204 may be automatically installed based on the connection of the printing apparatus 102 to the host computer 101. Specifically, when the printing apparatus 102 is connected to the host computer 101, the OS 214 acquires device identification information from the printing apparatus 102. An example of the device identification information is a hardware ID of the printing apparatus 102. The OS 214 may download the extension application 204 corresponding to the acquired device identification information from the server via the Internet and install the extension application 204. In other words, the print data generation software 202 and the extension application 204 are retained in the host computer 101 as separate files.

The print data generation software 202 and the extension application 204 can be updated for upgrade. The update processes are performed at different timings. More specifically, the timing when the host computer 101 acquires the print data generation software 202 and the timing when the host computer 101 acquires the extension application 204 are different. The trigger for the host computer 101 to acquire the print data generation software 202 and the trigger for the host computer 101 to acquire the extension application 204 are also different. When the extension application 204 is installed, the OS 214 associates the extension application 204 with the print data generation software 202 and the printing apparatus 102.

The extension application 204 according to the present exemplary embodiment includes a print setting screen extension unit 205, a skip control unit 206, a print function extension unit 207, a print data editing unit 208, a notification unit 209, and a capability information acquisition unit 211. The extension application 204 also includes shared information 210 that can be accessed in common from the units. The actual entity of the shared information 210 is a file stored in the external storage device 114 or information stored in the RAM 113. The extension application 204 writes and reads information to/from the shared information 210 by using an application programming interface (API) provided by the OS 214.

The extension application 204 may end its operation each time the processing of each unit is completed. In such a case, the OS 214 launches the extension application 204 each time a request to use one of the units is received. Different configurations are also conceivable. For example, the OS 214 may end the operation of the extension application 204 when the processing of the print setting screen extension unit 205 is completed, but maintain the extension application 204 running when the processing of the skip control unit 206 is completed.

The extension application 204 may cancel the processing of each unit halfway.

If the processing is cancelled, the job being processed on a print queue is deleted by the OS 214.

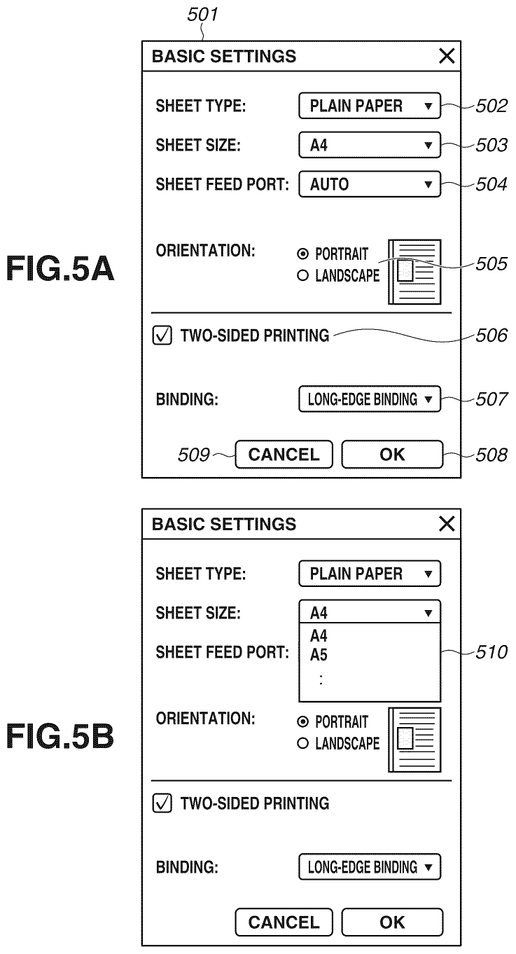

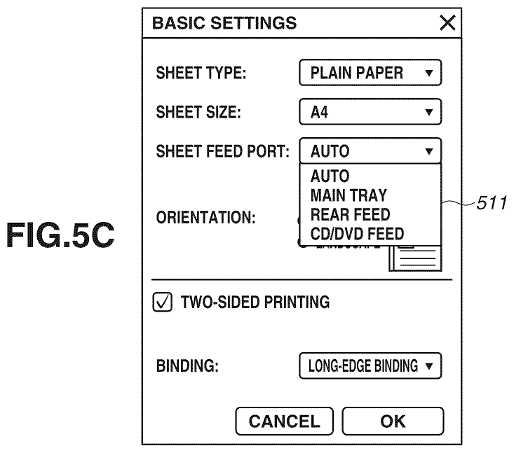

When receiving a print request from the user, the drawing application 201 issues a print instruction to the OS 214. In this configuration, as in the configuration of FIG. 2A, the drawing application 201 can display a print setting screen. The drawing application 201 may display its own print setting screen, or may be configured to display a print setting screen provided by the extension application 204 afterward. The print setting screen provided by the extension application 204 specifically refers to a print setting screen provided by the print setting screen extension unit 205 included in the extension application 204. Whether to display the print setting screen provided by the print setting screen extension unit 205 depends on the user's operation. Details of the print setting screen extension unit 205 will be described below with reference to FIGS. 5A to 5C.

When the drawing application 201 accepts the print request from the user and issues the print instruction to the OS 214, the OS 214 activates the skip control unit 206. The skip control unit 206 controls whether to skip print data generation processing by the print data generation software 202. After the skip control processing of the skip control unit 206, the OS 214 generates intermediate print data based on the print instruction output from the drawing application 201, and passes the intermediate print data to the print data generation software 202. If the skip control processing is not performed by the skip control unit 206, the print data generation software 202 here processes the intermediate print data into print data interpretable by the printing apparatus 102, and passes the print data to the print data editing unit 208. On the other hand, if the print data generation processing of the print data generation software 202 is skipped, the intermediate print data is passed to the print data editing unit 208 without being processed by the print data generation software 202. This enables the print data editing unit 208 to process the intermediate print data.

The print data editing unit 208 edits the intermediate print data passed from the print data generation software 202 or the print data processed by the print data generation software 202. Take N-up printing as an example of the editing. The print data editing unit 208 edits the intermediate print data or the print data so that an image including a plurality of pages of images laid out on one side of a sheet is output based on the print setting information about N-up printing, received from the OS 214. The print data editing unit 208 can display a graphical user interface (GUI) screen on the display unit 119, and can provide a function of displaying the layout result of the intermediate print data or the print data as a preview screen. The resulting print data 212 is not transmitted to the printing apparatus 102 with the GUI screen displayed on the display unit 119 by the print data editing unit 208 open. The transmission processing of the print data 212 is triggered by closing the GUI screen.

After the print data editing unit 208 edits the print data 212, the print data 212 is passed to the printing apparatus 102. The printing apparatus 102 prints on a recording medium such as a sheet of paper based on the accepted print data 212.

The print data editing unit 208 may be configured to output the print data 212 to an application 213 other than the drawing application 201. An example where the print data editing unit 208 outputs the print data 212 to the application 213 will be described below.

If the print data generation processing of the print data generation software 202 is skipped by the skip control unit 206, the print data editing unit 208 may convert the received intermediate print data into print data interpretable by the printing apparatus 102. To convert the intermediate print data into the print data, the print data editing unit 208 may use functions provided by the OS 214.

The extension application 204 includes the print function extension unit 207. The print function extension unit 207 can edit the PDC 203 generated by the print data generation software 202. The PDC 203 generated by the print data generation software 202 will be described below. By editing the PDC 203, the print function extension unit 207 can add functions provided by the extension application 204, and add functions supported by the printing apparatus 102 but not by the print data generation software 202. Hereinafter, a print setting screen shall refer to the print setting screen provided by any of the OS 214, the drawing application 201, and the print setting screen extension unit 205 unless otherwise specified.

When the extension application 204 is associated with the printing apparatus 102 and the print data generation software 202 for the first time, the OS 214 activates the print function extension unit 207. The OS 214 may also activate the print function extension unit 207 at other timing such as when the OS 214 is started up. This enables the print function extension unit 207 to detect extended functions and add the extended functions to the PDC 203 in a case where an optional apparatus (such as a finisher) is added to the printing apparatus 102 afterward and printing-related functions are extended.

The extension application 204 also includes the notification unit 209. The notification unit 209 can display a notification to the user in response to the occurrence of an error in the printing apparatus 102. For example, if a paper-out error occurs in the printing apparatus 102, the extension application 204 detects the error, and the OS 214 displays a message on the display unit 119 using an OS function called toast notification. If the user presses the toast notification, the notification unit 209 of the extension application 204 is called by the OS 214 and displays a UI screen of the notification unit 209. The UI screen of the notification unit 209 can display a detailed message about the paper-out error and a sheet replenishment method, for example.

The configuration of the extension application 204 for implementing the present exemplary embodiment is not limited to that including all the foregoing functions (units). Only some of the functions may be included, or other functions may also be included. The extension application 204 is sometimes referred to simply as printing software. As mentioned above, the extension application 204 can be said to include at least one of the functions 205 to 209 and 211 illustrated in FIG. 2B.

### Example of PDC Generated by Print Data Generation Software 202

The print data generation software 202 initially acquires the attribute data on the printing apparatus 102 connected to the host computer 101, and generates the PDC 203 based on the attribute data. The attribute data to be acquired from the printing apparatus 102 is information including the information that the user can set as print settings when the printing apparatus 102 performs printing.

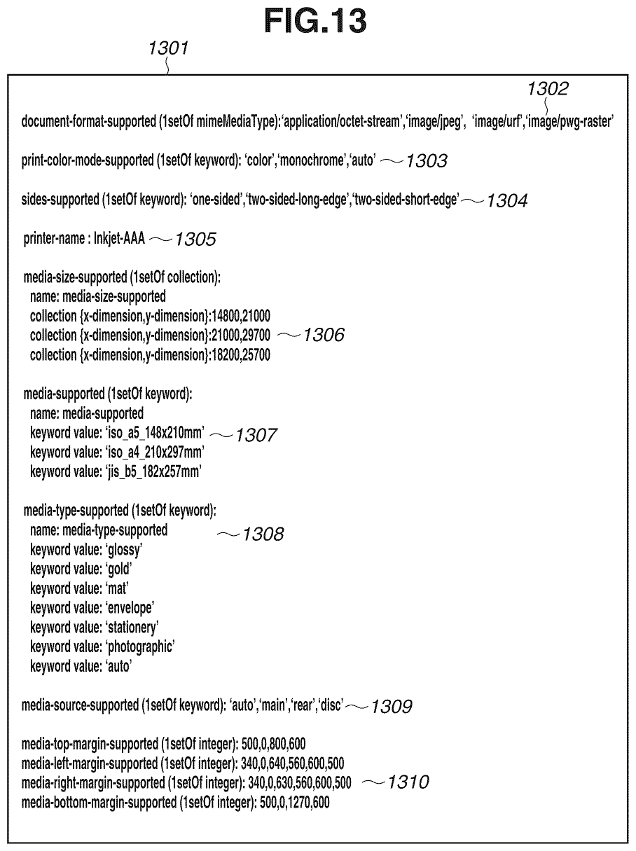

An example of the response that the print data generation software 202 acquires by issuing the IPP Get-Printer-Attributes operation to the printing apparatus 102 will be described with reference to FIG. 13. Information 1301 is an example of the response that can be acquired by issuing the IPP Get-Printer-Attributes operation to the printing apparatus 102. The information 1301 includes attribute information (features) representing functions that can be specified for the printing apparatus 102 as IPP attributes, and setting values (options) related to the attribute information. As illustrated in the information 1301, information about functions (features) such as size and media and setting values (options) settable for the functions can be acquired from the printing apparatus 102. document-format-supported illustrated in information 1302 describes print data formats that the printing apparatus 102 can accept. For example, the information 1302 indicates that the printing apparatus 102 supports data formats ‘application/octet-stream’, ‘image/jpeg’, ‘image/urf’, and ‘image/pwg-raster’. print-color-mode-supported illustrated in information 1303 describes color modes that can be specified during printing by the printing apparatus 102. For example, the information 1303 indicates that the printing apparatus 102 supports color modes ‘color’, ‘monochrome’, and ‘auto’ (auto select). sides-supported illustrated in information 1304 describes alternatives that the printing apparatus 102 can select for two-sided printing. For example, the information 1304 indicates that the printing apparatus 102 supports two-sided printing with two-sided-short-edge (short-edge binding) and two-sided-long-edge (long-edge binding). printer-name illustrated in information 1305 describes the name of the printing apparatus 102. The information 1305 indicates that the name of the connected printing apparatus 102 is “Inkjet-AAA”. media-size-supported illustrated in information 1306 describes media sizes supported by the printing apparatus 102 using information indicating a width and height in units of 1/100 mm. For example, the information 1306 indicates that the printing apparatus 102 supports printing on sheets of A5, A4, and B5 sizes. media-supported illustrated in information 1307 describes the names of the media sizes supported by the printing apparatus 102. media-type-supported illustrated in information 1308 describes media types supported by the printing apparatus 102. For example, the information 1308 indicates that the printing apparatus 102 supports printing on glossy, gold, mat, stationary, photographic, and envelope media. glossy represents glossy standard paper. gold represents glossy gold paper. mat represents mat photo paper. stationary represents plain paper. photographic represents photo paper. envelope represent envelopes.

media-source-supported illustrated in information 1309 lists feed methods supported by the printing apparatus 102. For example, the information 1309 indicates that the printing apparatus 102 supports print sheet feed methods auto (auto select), main (main tray), rear (rear tray), and disc (Compact Disc [CD] /Digital Versatile Disc [DVD] tray). media-top (bottom/right/left)-margin-supported illustrated in information 1310 describes the lengths of margins that can be set during printing by the printing apparatus 102. For example, the information 1310 indicates that the margin at the sheet top can be 5 mm, 0 mm, 8 mm, and 6 mm. The information 1310 also indicates that the margin on the left of the sheet can be 3.4 mm, 0 mm, 6.4 mm, 5.6 mm, 6 mm, and 5 mm. The information 1310 also indicates that the margin on the right of the sheet can be 3.4 mm, 0 mm, 6.3 mm, 5.6 mm, 6 mm, and 5 mm. The information 1310 also indicates that the margin at the sheet bottom can be 5 mm, 0 mm, 12.7 mm, and 6 mm. The attribute values illustrated in the information 1302 to 1310 are merely examples. In fact, attribute values other than those illustrated are also included. The information 1301 is also merely an example. An actual response to be acquired by issuing the IPP Get-Printer-Attributes operation to the printing apparatus 102 also includes attribute information other than illustrated.

The print data generation software 202 acquires information such as the foregoing information 1301 by issuing the IPP Get-Printer-Attributes operation to the printing apparatus 102, and generates the PDC 203 based on the acquired information.

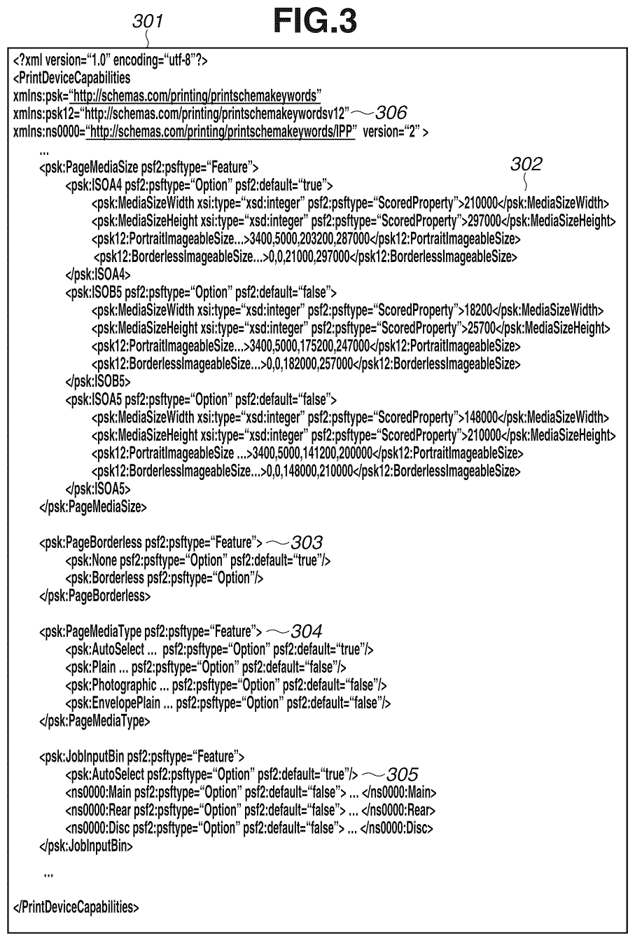

An example of the PDC 203 generated by the print data generation software 202 will be described by using information 301 illustrated in FIG. 3. The PDC 203 is written in XML format as in the information 301 illustrated in FIG. 3, and describes the attribute information (features) representing the functions that can be specified for the printing apparatus 102 and the setting values (options) related to the attribute information.

Information 306 describes character strings defined as the prefixes (Prefixes) of namespaces (NameSpaces) to which the features and options described in information 302 to 305 to be described below belong. NameSpace represents a set or range to which features or options belong. NameSpace is used to uniquely identify the features or options when the print data generation software 202, the OS 214, or the extension application 204 refers to the PDC 203 or PT/PC. For example, if there are features or options defined by the same name, NameSpace can express whether each feature or option is defined by the OS standard or originally defined by the vendor. Specifically, suppose that xmlns:psk=“http://schemas.com/printing/printingschemakeywords” is defined by the information 306. In such a case, that features or options described in the subsequent information 302 or 303 belong to the foregoing NameSpace can be defined by attaching the prefix “psk” thereto. If the foregoing NameSpace is one defined by the OS standard, the NameSpace can express that the features or options belong to the OS standard. In such a manner, NameSpace indicates the set or range to which features or options belong.

The information 302 indicates that ISOA4, ISOA5, and ISOB5 can be specified as PageMediaSize (sheet size). Here, PageMediaSize represents the function (feature), and ISOA4 and the like represent the setting values (options) for the function. The functions (features) and setting values (options) of the functions to be described below are also described in a similar notation. The information 303 indicates that Borderless (borderless) and None (bordered) can be set as PageBorderless (borderless print setting). The information 304 indicates that Plain (plain paper), Photographic (photo paper), and EnvelopePlain (envelope) can be specified as PageMediaType (media). The information 305 indicates that Main (main tray), Rear (rear tray), and Disc (CD/DVD tray) can be specified as JobInputBin (feed method). As described above, the print data generation software 202 or the OS 214 issues the IPP Get-Printer-Attributes operation to the printing apparatus 102. The print data generation software 202 or the OS 214 acquires information such as the foregoing information 1301 as the response to the operation, and generates the PDC 203 based on the acquired information. The PDC 203 generated here describes only features and options already known to the OS 214. In other words, vendor-specific information such as media: glossy gold and media: mat photo paper illustrated in the information 1308 is not included in the PDC 203, and only standard media such as plain paper and photo paper are included in the PDC 203. The PDC 203 generated by the print data generation software 202 or the OS 214 thus describes only standard or general-purpose features and options included in the information 1301 acquired from the printing apparatus 102.

The print function extension unit 207 of the extension application 204 edits the PDC 203 generated by the print data generation software 202 or the OS 214. This can extend the functions usable by the user when the printing apparatus 102 prints using the print data generation software 202. Specifically, the print function extension unit 207 adds new features and options to the PDC 203. The print function extension unit 207 can thereby add functions provided by the extension application 204 and add functions supported by the printing apparatus 102 but not by the print data generation software 202. By editing the PDC 203, the print function extension unit 207 can not only add functions but delete existing functions or add exclusive relationships (prohibition information) between the setting values of the print functions as well. The functions for the print function extension unit 207 to add to the PDC 203 may be determined by using the information 1301 that the capability information acquisition unit 211 acquires from the printing apparatus 102. The capability information acquisition unit 211 acquires the information (capability information) 1301 by issuing the IPP Get-Printer-Attributes operation to the printing apparatus 102. The print function extension unit 207 may be configured to add features and options that are included in the capability information 1301 acquired by the capability information acquisition unit 211 and not in the existing PDC 203 to the PDC 203. The functions for the print function extension unit 207 to add to the PDC 203 may be determined by other methods. For example, the print function extension unit 207 may determine the functions to be added to the PDC 203 based on information stored in the shared information 210 in advance.

### Example of Screen Displayed by Print Setting Screen Extension Unit

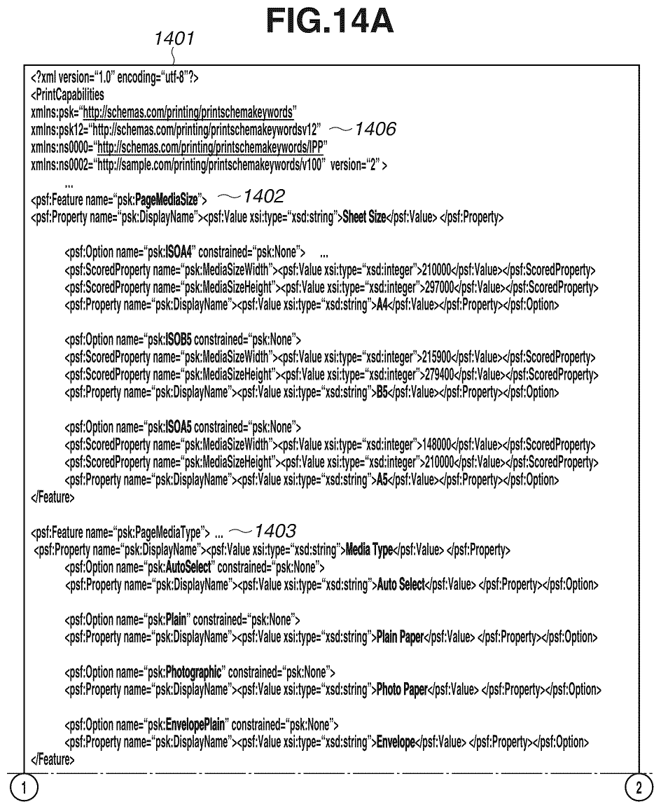

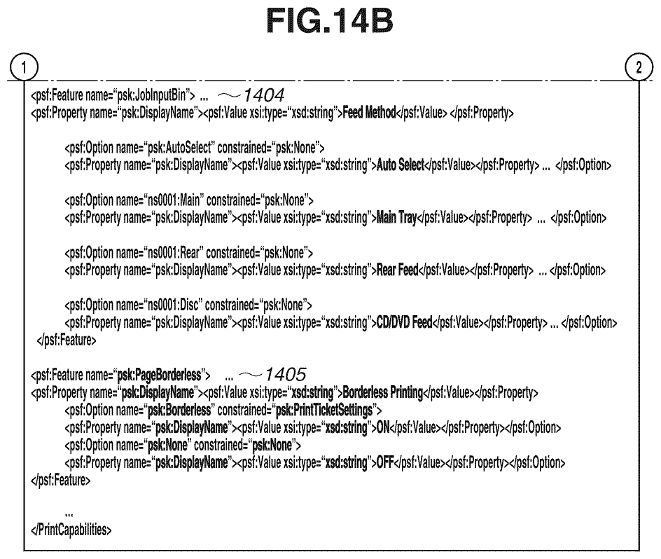

Before describing an example of the display of the print setting screen by the print setting screen extension unit 205, PC will be described in conjunction with a specific example. PC is generated by the print data generation software 202 based on the content of the PDC 203, and describes print setting items settable for the printing apparatus 102. As with the PDC 203, PC is written in XML format. FIGS. 14A and 14B illustrate a specific example thereof. The PC represented by information 1401 is generated by the print data generation software 202 based on the information (PDC) 301. Since PC is generated based on the PDC 301, the content of the PC is similar to that of the PDC 301. The characteristics of information 1401 to 1405 are similar to those of information 301 to 305, and a description thereof will thus be omitted. The information 1402 to 1405 indicates the following: Features “sheet size”, “media type”, “feed method”, and “borderless printing” can be set as print settings related to the printing apparatus 102, “A4”, “B5”, and “A5” can be set for “sheet size”, “Auto Select”, “Plain Paper”, “Photo Paper”, and “Envelope” can be set for “media type”, “Auto Select”, “Main Tray”, “Rear Feed”, and “CD/DVD Feed” can be set for “feed method”, and “ON” and “OFF” can be set for “borderless printing”. A difference between the PDC 301 and PC 1401 is that DisplayNames are described as the attribute values of the features and options. DisplayNames are values indicating the text phrases with which the respective features and options are displayed on the print setting screen. In such a manner, PC lists the settable features and their option values for the printing apparatus 102.

Next, the print setting screen displayed by the print setting screen extension unit 205 will be described with reference to FIGS. 5A to 5C. PC is generated based on the

PDC 203 edited by the print function extension unit 207. FIG. 5A illustrates a print setting screen 501, which is an example of the screen displayed by the print setting screen extension unit 205 based on the generated PC. The screens illustrated in FIGS. 5A to 5C are merely examples and not based on the foregoing PC 1401. A control 502 is a control item capable of setting the type of sheets to be used for printing. For example, “AutoSelect” (auto select), “Plain” (plain paper), “Photographic” (photo paper), and “EnvelopePlain” (envelope) defined in the information 1403 can be set using the control 502.

A control 503 is a control item capable of setting the size of sheets to be used for printing. For example, the items defined in the information 1402, such as A4, B5, and A5, can be set. A list 510 in FIG. 5B illustrates the display state of the control 503 expanded. The user can select a sheet size from the expanded list.

A control 504 is a control item capable of setting the feed method of printing sheets by the printing apparatus 102. For example, the items defined in the information 405, such as “AutoSelect” (auto select), “Main” (main tray), “Rear” (rear feed), and “Disc” (CD/DVD feed), can be selected using the control 504. A list 511 in FIG. 5C illustrates the display state of the control 504 expanded. The user can select a feed method from the expanded list.

A control 505 is a control item capable of setting printing orientation, whereby portrait and landscape can be set. A control 506 is a control item capable of switching two-sided printing ON and OFF. A control 507 is a control item capable of setting the binding direction during two-sided printing. For example, items such as long-edge binding and short-edge binding can be set.

A control 509 is a cancel button, whereby the screen is closed without applying the settings. A control 508 is an OK button, whereby the screen is closed with the settings applied.

The screens illustrated in FIGS. 5A to 5C are merely examples. In fact, the screen may be configured so that other features and options can be set. Information other than the print settings may be displayed.

### Issue with Print Data Generation Software

Up to this point, the printing system including the print data generation software 202 and the extension application 204 has been described. The print data generation software 202 and the extension application 204 can be used by connecting the host computer 101 to the printing apparatus 102 and the OS 214 generating a print queue corresponding to the printing apparatus 102. Specifically, when the printing apparatus 102 is connected to the host computer 101, the OS 214 acquires the device identification information from the printing apparatus 102, and generates a print queue corresponding to the print data generation software 202. The OS 214 downloads the extension application 204 corresponding to the acquired device identification information from the server via the Internet, and installs the extension application 204. Without the host computer 101 being connected to the printing apparatus 102, the print queue is not generated. Without the host computer 101 being connected to the printing apparatus 102, the extension application 204 is not associated, either, since the device identification information is unable to be acquired. If the user wants to output print data not to the printing apparatus 102 but to the application 213, the user is therefore unable to use the printing system including the print data generation software 202 and the extension application 204. To output print data to the application 213, the printing system is desirably configured so that the OS 214 can generate a print queue corresponding to the print data generation software 202 even without the host computer 101 and the printing apparatus 102 being connected.

In addition to the components described so far, this configuration includes a unit by which the application 213 instructs the OS 214 to generate a virtual print queue to which the print data generation software 202 is assigned. The OS 214 includes a unit that can generate a print queue to which the print data generation software 202 is assigned without connection with the printing apparatus 102. Moreover, the extension application 204 dedicated to the application 213 includes a unit that provides the application 213 with print data generated based on intermediate print data submitted to the foregoing queue. The issue mentioned above is solved by such a configuration.

This configuration enables the OS 214 to generate a print queue corresponding to the print data generation software 202 without the host computer 101 and the printing apparatus 102 being connected. Such a print queue generated without connection with the printing apparatus 102 will hereinafter be referred to as a virtual queue. A print queue actually associated with the printing apparatus 102 will be referred to simply as a print queue. The extension application 204 can be associated with the virtual queue. As a result, if print instructions are given with the virtual queue as the printing destination, print data processed and generated by the print data editing unit 208 based on intermediate print data generated by the OS 214 can be output to the application 213. Such an operation is possible because, as described above, the intermediate print data is passed not to the print data generation software 202 but to the print data editing unit 208 of the extension application 204 by the skip instruction from the skip control unit 206. In other words, by the user issuing an instruction to print desired data to the virtual queue dedicated to the application 213, the desired data that is converted print data can be imported into the application 213.

In the present exemplary embodiment, the application 213 is a layout editing application or a document management application, for example. Layout editing applications and document management applications desirably retain data to be laid out or managed in a unified format. Examples of the unified format include XPS format and Portable Document Format (PDF). The data format of a document file or image file output from the drawing application 201 can be unknown to the application 213.

If the drawing application 201 can print with the virtual queue being specified, the output of the drawing application 201 can be converted into print data (XPS or PDF). In other words, if the user prints the document file or image file generated using the drawing application 201 to the virtual queue, the file is converted into print data by the extension application 204. By importing converted print data, the application 213 can retain various types of data in the unified format.

The application 213 may be an application for the vendor's own cloud print service. In cloud printing, print data is transmitted to each printing apparatus via a cloud server on the Internet. The host computer 101 and the printing apparatus 102 therefore do not need to be connected via the input/output interface 116, and the application 213 can simply transmit print data to the cloud server. Since the print data for the application 213 to transmit to the cloud server is desirably in a predetermined format interpretable by the printing apparatus 102, the present configuration capable of converting various types of data into the unified format is useful. According to this configuration, the cloud print service can take in various types of data in a predetermined format by taking in print data converted by the extension application 204, and can thus cloud-print various types of data.

### Example of Generation of Virtual Queue by Print Data Generation Software

A specific example of the present exemplary embodiment will hereinafter be described by using a layout editing application as an example of the application 213. The application 213 can freely edit, on a layout editing screen of the application 213, the layout of a plurality of objects to be laid out, imported in XPS format, and issue print instructions with the printing apparatus 102 being specified. The application 213 is named “Layout App”.

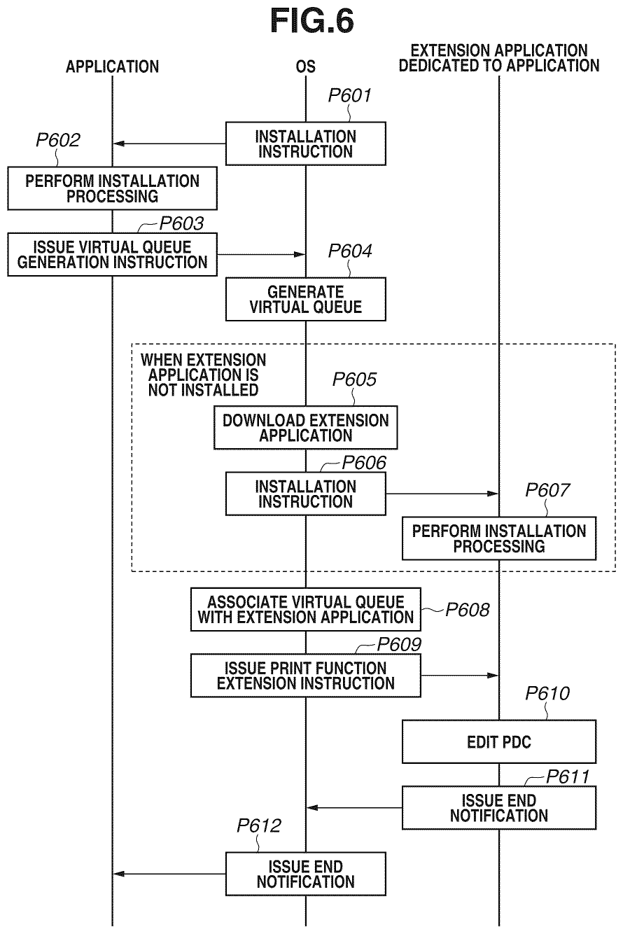

FIG. 6 is a sequence diagram when the application 213 is installed on the OS 214. In step P601, the OS 214 initially accepts an installation instruction for the application 213 from the user. Accepting the installation instruction for the application 213 from the user, the OS 214 executes the installer of the application 213 and performs installation of the application 213. The application 213 is installed by the host computer 101 reading a Compact Disc Read-Only Memory (CD-ROM) bundled with the printing apparatus 102 and executing the installer. The application 213 may be available from the website of a company that manufactures or sells the printing apparatus 102.

In step P602, the application 213 accepting the installation instruction from the OS 214 performs installation processing. The installation processing includes processing for deploying modules that perform various processes of the application 213 to the external storage device 114 of the host computer 101. As the installation processing of step P602, the application 213 also performs processing for registering a Uniform Resource Identifier (URI) indicating the location of a launching module of the application 213 in the external storage device 114 with the OS 214. For example, the application 213 registers the location of the launching module of the application 213 using a URI “LayoutAppLauncher:”. This enables different applications on the OS 214 to launch the application 213 by specifying the URI “LayoutAppLauncher:” using the API of the OS 214.

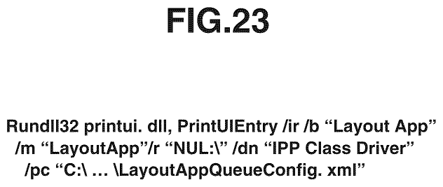

After the completion of the installation processing, in step P603, the application 213 issues a virtual queue generation instruction to the OS 214. The virtual queue generation instruction that the application 213 issues to the OS 214 instructs the OS 214 to generate a virtual queue to which the print data generation software 202 is assigned. The virtual queue generation instruction is issued using a function printui.dll included in the OS 214. Specifically, the virtual queue generation instruction is issued by the application 213 executing the command illustrated in FIG. 23.

Details of the command will be described. printui.dll is an executable file including functions to be used in a printer configuration dialog box, included in the OS 214. Rundll32 printui.dll, PrintUIEntry specifies the foregoing executable file. /ir is a parameter for instructing the generation of a print queue with a driver installed on the OS 214 being specified. /b is a parameter for specifying the name of the print queue to be generated, and the subsequent character string “Layout App” specifies the name. Since printing to the virtual queue generated here results in data output to the application 213, the name of the application 213 is desirably used as the print queue name so that the user can easily identify the print queue. However, other names may be used. /m is a parameter for specifying the model name of a printing apparatus, and the subsequent character string “LayoutApp” specifies the model name of the virtual printing apparatus. As will be described in detail below, the model name shall be a name that can uniquely identify the application 213. /r is a parameter for specifying the port for the print queue to output data to, and the subsequent character string “NUL:\” specifies a NULL port. /dn is a parameter for specifying the driver name to be assigned to the generated queue, and the subsequent character string “IPP Class Driver” specifies the print data generation software 202. /pc is a parameter indicating that a file describing capability information related to the printing to the virtual queue is specified. The subsequent character string “C:\. . .\LayoutAppQueueConfig.xml” specifies the location of the file describing the capability information. As described above, the print data generation software 202 generates the PDC 203 of the print queue associated with the printing apparatus 102 based on the capability information acquired from the printing apparatus 102. However, since the print queue to be generated here is not associated with the printing apparatus 102, the print data generation software 202 is unable to acquire the capability information for generating the PDC of the virtual queue. The print data generation software 202 then generates the PDC of the virtual queue based on the capability information described in the file specified by the application 213 using the parameter /pc.

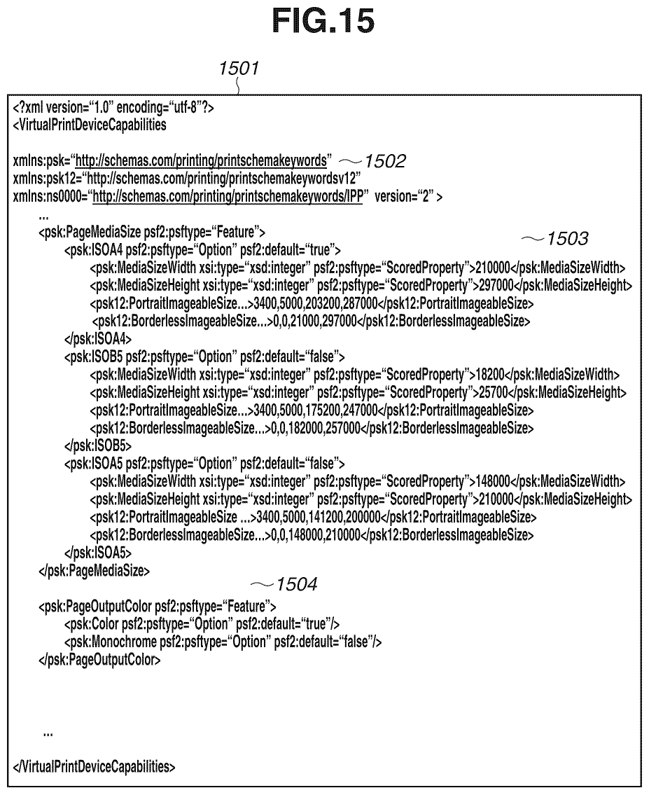

FIG. 15 illustrates an example of the capability information about the printing to the virtual queue, specified by application 213 using the parameter /pc. Information 1501 is an example of the capability information about the printing to the virtual queue, described in the file specified by the application 213 using the parameter /pc. While the information 1501 is described in XML format as an example, the information 1501 may be described in other formats as long as interpretable by the print data generation software 202. As described in conjunction with the information 306, information 1502 is information defining the prefixes of name spaces for features and options. Information 1503 indicates that ISOA4, ISOA5, and ISOB5 can be specified as PageMediaSize (print data size) during printing to the virtual queue. Information 1504 indicates that Color (color) and Monochrome (monochrome) can be set as PageOutputColor (color setting) during printing to the virtual queue. Since the layout editing application is assumed as an example of the application 213, the printing to the virtual queue is merely intended to generate print data and it is therefore sufficient to define only capability information related to the generation of print data. Settings related to sheets to be actually printed can be set when the application 213 instructs the printing apparatus 102 to print. The information 1501 is merely an example. In fact, information other than the illustrated capability information may be included. The foregoing does not apply, however, if the application 213 is an application for the cloud print service mentioned above. In such a case, the application 213 is an application in charge of data transmission to the cloud server, and not intended to configure print settings. The settings related to sheets to be actually printed are therefore desirably configured as well in printing via the virtual queue. The print settings configured in printing via the virtual queue can be included into the data that the extension application 204 outputs to the application 213, and the application 213 can transmit the print setting information to the cloud server along with the image to be printed. If the application 213 is the foregoing application for the cloud print service, the capability information about the printing via the virtual queue is thus desirably equivalent to the capability information about the printing apparatus 102, such as the information 1301. The capability information related to the printing via the virtual queue can thus vary depending on the type of the application 213. In such a manner, the application 213 can instruct the OS 214 to generate a virtual queue to which the print data generation software 202 is assigned, using the function printui.dll included in the OS 214.

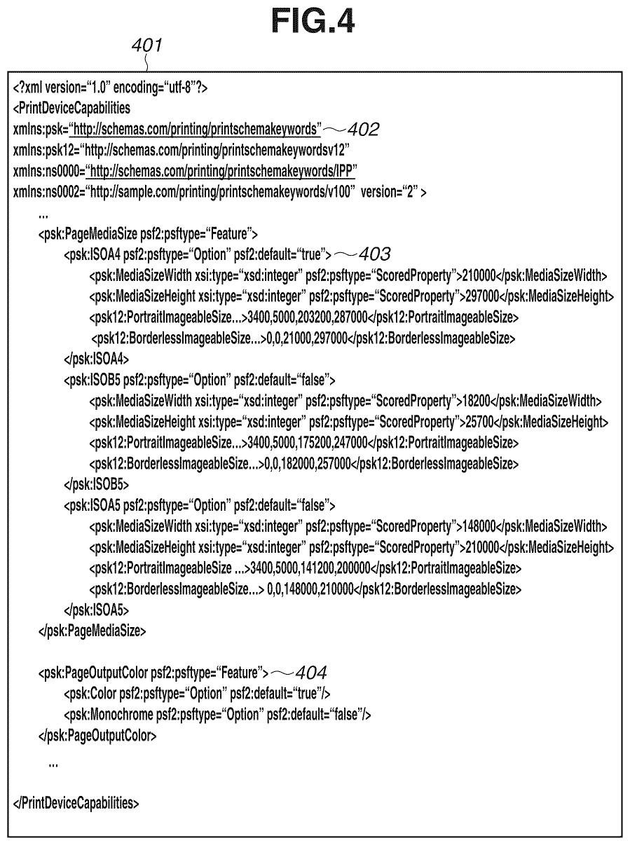

In step P604, the OS 214 accepting the virtual queue generation instruction from the application 213 generates the virtual queue based on the instruction content accepted from the application 213. In the foregoing example, the OS 214 generates a virtual queue of which the output port is the NULL port and the name is “Layout App”, and that is assigned the print data generation software 202. Although not illustrated in the diagram, the OS 214 here issues a PDC generation instruction to the print data generation software 202. The print data generation software 202 generates the PDC of the virtual queue based on the capability information described in the file “C:\. . .\LayoutAppQueueConfig.xml” specified using the parameter /pc. FIG. 4 illustrates an example of the PDC generated by the print data generation software 202 here. Information 401, or PDC 401, is generated by the print data generation software 202 based on the information 1501. Information 402 to 404 is similar to the information 1502 to 1504, and a description thereof will be omitted.

If the extension application 204 dedicated to the application 213 is not installed on the OS 214, then in step P605, the OS 214 downloads the extension application 204 dedicated to the application 213 from the server via the Internet. The OS 214 determines the extension application 204 to be downloaded based on the model name “LayoutApp” of the generated virtual queue. After the extension application 204 dedicated to the application 213 is downloaded, in step P606, the OS 214 executes the installer of the extension application 204. In step P607, the extension application 204 performs installation processing. The installation processing of the extension application 204 in step P607 includes processing for deploying modules that perform various processes of the units of the extension application 204 to the external storage device 114 of the host computer 101.

In step P608, the OS 214 associates the virtual queue with the extension application 204. This association in step P608 enables the OS 214 to activate various units of the extension application 204 when print instructions for the virtual queue are accepted.

After the completion of the association processing in step P608, in step P609, the OS 214 issues a print function extension instruction, i.e., an instruction to edit the PDC 401 to the extension application 204. The OS 214 activates the print function extension unit 207 of the extension application 204 and issues the print function extension instruction at timing when the extension application 204 is associated with the virtual queue. Aside from the timing when the extension application 204 is associated for the first time, the OS 214 also activates the print function extension unit 207 and issues the print function extension instruction at timing when the print setting screen is opened by the print setting screen extension unit 205.

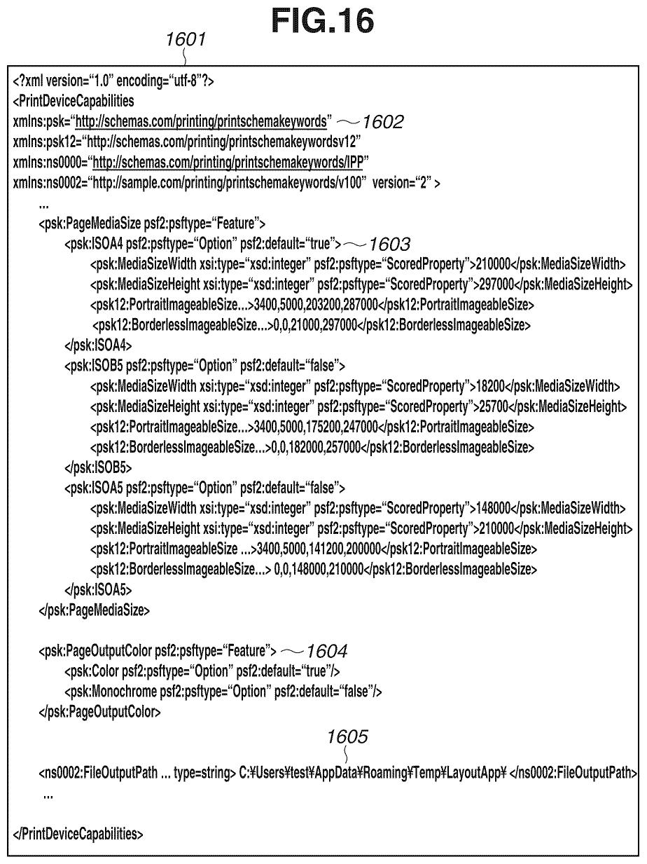

In step P610, the print function extension unit 207 of the extension application 204 accepting the print function extension instruction from the OS 214 acquires the PDC 401 generated by the print data generation software 202 and edits the PDC 401. Specifically, the print function extension unit 207 describes in the PDC 401 information that specifies the area for the print data editing unit 208 to temporarily store print data for the purpose of outputting the print data to the application 213. As described above, the information described in the PDC 401 is reflected on PC. The application 213 can refer to the PC. By referring to the PC, the application 213 can thus determine the area where the print data editing unit 208 stores print data. The processing by which the application 213 acquires the print data will be described below. FIG. 16 illustrates an example of the PDC 401 edited by the print function extension unit 207 in step P610. Information 1601 is the PDC 401 edited by the print function extension unit 207. Information 1602 to 1604 is similar to the information 402 to 404, and a description thereof will be omitted. Information 1605 is information added to the PDC 401 by the print function extension unit 207. The information 1605, or FileOutputPath, includes a character string describing the area where the print data editing unit 208 temporarily stores generated print data. In this example, the information 1605 indicates that the print data editing unit 208 stores print data in the area C:\Users\test\AppData\Roaming\Temp\LayoutApp\ of the external storage device 114 of the host computer 101. The area described in the information 1605 may be freely determined by the extension application 204, determined using information indicating the storage area for LayoutApp that is statically retained by the extension application 204, or determined by other methods. The print function extension unit 207 may add capability information other than the foregoing to the PDC 401. For example, if the application 213 is an application for a cloud print service, the print function extension unit 207 may add capability information equivalent to the capability information 1501 about the printing apparatus 102 to the PDC 401. The information for the print function extension unit 207 to add to the PDC 401 may be acquired by other methods, such as from a not-illustrated server.

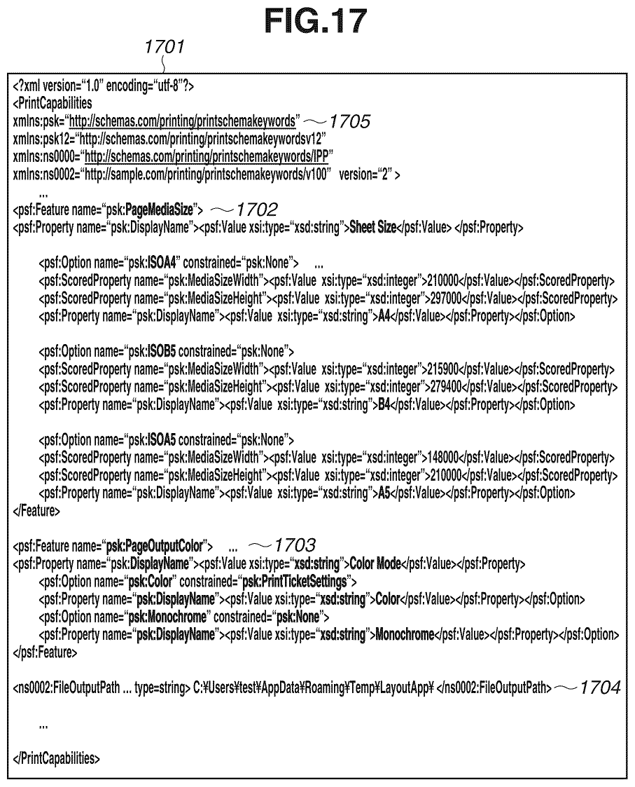

When the print function extension unit 207 processes the PDC 401 into the PDC 1601, the information in the PC is also updated. FIG. 17 illustrates an example of the PC on which the PDC 1601 is reflected. Information 1701 represents the PC based on the PDC 1601. Information 1702 and 1705 is similar to the information 1402 and 1406, respectively, and a description thereof will thus be omitted. Information 1703 indicates that options for the color mode function, “Color” and “Monochrome”, can be set as print settings for the virtual queue. Similar to the information 1605, information 1704 is information indicating the area where the print data editing unit 208 stores generated print data. The application 213 can determine the area where the print data editing unit 208 stores print image by referring to the information 1704 in the PC 1701.

As described above, in step P610, the print function extension unit 207 edits the PDC 401 as the print function extension function. The information added to the PDC 401 by the print function extension unit 207 is merely an example, and other print functions related to the generation of print data to the virtual queue than those illustrated, such as sheet size, may be added to the PDC 401.

After the completion of the print function extension processing of step P610, in step P611, the extension application 204 issues an end notification of the print function extension processing to the OS 214. In step P612, the OS 214 receiving the end notification of the print function extension processing issues an end notification of the virtual queue generation to the application 213.

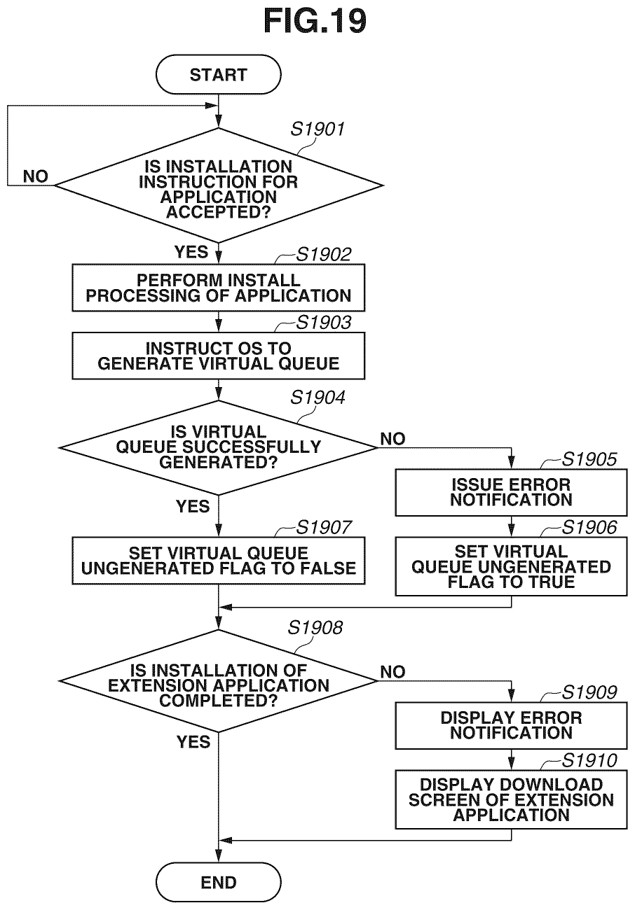

Now, details of the operation of the application 213 illustrated in FIG. 6 will be described with reference to the flowchart of FIG. 19. The flowchart illustrated in FIG. 19 is implemented by the CPU 111 executing the program of the application 213.

In step S1901, the CPU 111 determines whether an installation instruction for the application 213 is accepted from the OS 214. If the installation instruction is not accepted (NO in step S1901), the processing returns to step S1901. If the installation instruction is accepted (YES in step S1901), the processing proceeds to step S1902.

In step S1902, the CPU 111 performs the installation processing of the application 213.

In step S1902, the CPU 111 stores a file describing the capability information for the application 213 to store into an area specified by a file path. This file path is the path to be notified to the OS 214 in step S1903 and that is specified in the command issued in step P603 of FIG. 6.

In step S1903, the CPU 111 instructs the OS 214 to generate a virtual queue. The CPU 111 instructs the OS 214 to generate the virtual queue by issuing the command described in step P603 of FIG. 6.

In step S1904, the CPU 111 determines whether the virtual queue is successfully generated. If the CPU 111 receives information indicating that the virtual queue is successfully generated from the OS 214 (YES in step S1904), the processing proceeds to step S1907. If the CPU 111 receives information indicating that the virtual queue fails to be generated from the OS 214, or does not receive the information indicating that the virtual queue is successfully generated before a lapse of a predetermined time from the instruction to generate the virtual queue (NO in step 1904), the processing proceeds to step S1905.

In step S1905, the CPU 111 issues an error notification. For example, the CPU 111 displays a not-illustrated error message on the display unit 119. Alternatively, step S1905 may be skipped, and the processing may proceed to step S1906.

In step S1906, the CPU 111 sets a virtual queue ungenerated flag indicating that the virtual queue is not generated to TRUE. The CPU 111 refers to the virtual queue ungenerated flag when launching the application 213. If the virtual queue ungenerated flag is set to TRUE, the CPU 111 performs the processing of steps S1903 to S1909 in FIG. 19. The virtual queue can thereby be generated in launching the application 213 even if the virtual queue fails to be generated during the installation of the application 213.

In step S1907, the CPU 111 sets the virtual queue ungenerated flag to FALSE.

In step S1908, the CPU 111 determines whether the installation of the extension application 204 dedicated to the application 213 is completed. The CPU 111 refers to the properties of the virtual queue, and determines whether an application ID of the extension application 204 is set for the virtual queue. If the application ID of the extension application 204 is set (YES in step 1908), the processing illustrated in this flowchart ends. If the installation of the extension application 204 is not completed (NO in step S1908), the processing proceeds to step S1909. In step S1909, the CPU 111 displays an error notification. In step S1909, the CPU 111 displays an error message on the display unit 119. In step S1910, the CPU 111 displays a download screen of the extension application 204. The application 213 stores the Universal Resource Locator (URL) of the download page (download screen) of the extension application 204 in advance. The CPU 111 accesses the URL stored in the application 213 and displays the download page of the extension application 204. When the download of the extension application 204 is completed, the CPU 111 may request the OS 214 to perform processing for associating the virtual queue with the extension application 204.

The error notification displayed in step S1909 may display a screen for accepting the user's instruction about whether to display the download page of the extension application 204. Whether to perform step S1910 may be switched depending on the user instruction.

Up to this point, an example of the processes related to the installation of the application 213 has been described. As has been described above, the application 213 issues the virtual queue generation instruction to the OS 214 during its own installation, so that the OS 214 generates a virtual queue corresponding to the application 213. In a process to be described below, data printed to the virtual queue is converted into a predetermined format by the print data editing unit 208 and output to the application 213.

### Example of Data Output to Application Using Virtual Queue

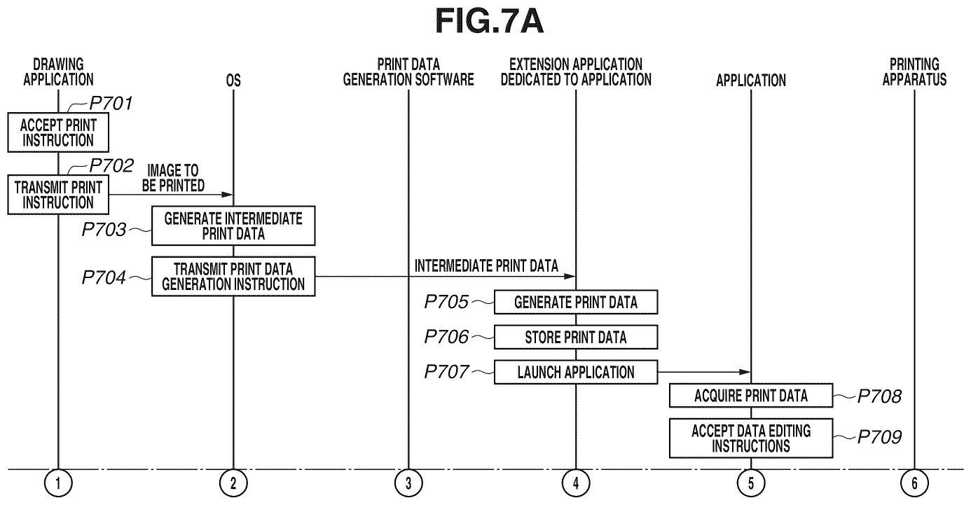

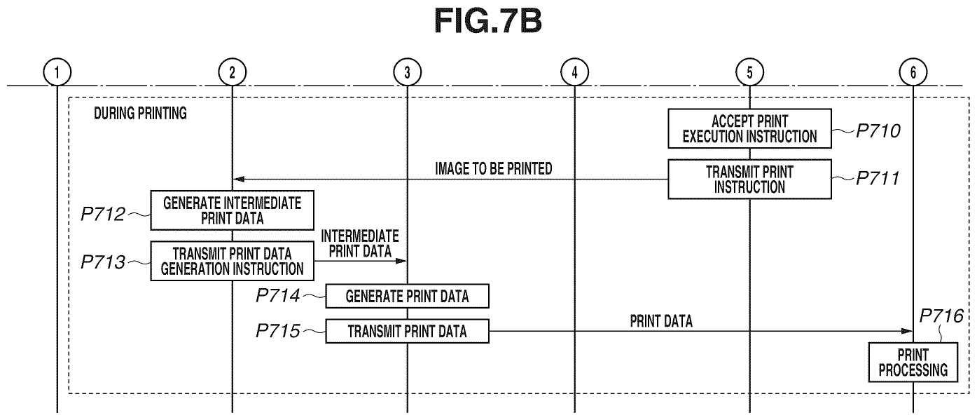

FIGS. 7A and 7B are sequence diagrams of processes related to data output to the application 213 and printing from the application 213 according to the present exemplary embodiment. The processes during the data output to the application 213 and the printing from the application 213 will be described with reference to FIGS. 7A and 7B.

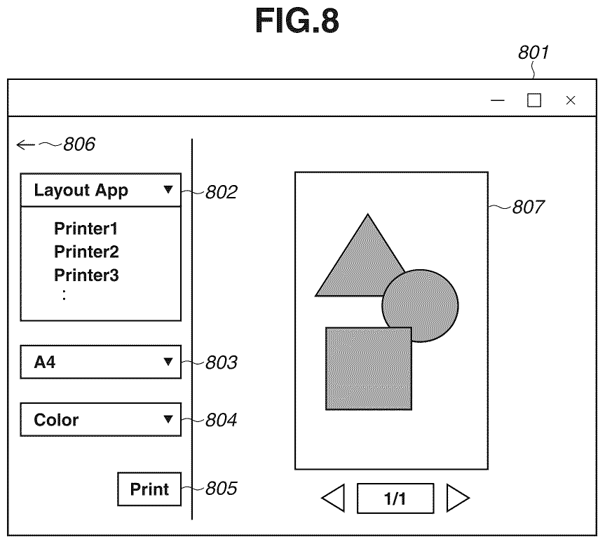

The processes related to the data output to the application 213 will initially be described. The data output to the application 213 is implemented by printing to the virtual queue. In step P701, the drawing application 201 initially accepts a print instruction from the user. Suppose that the user generates a document or drawing using the drawing application 201 in advance, and specifies the document or drawing as data to be printed. To output the data to the application 213, the user selects the virtual queue corresponding to the application 213 as a printing destination on the print setting screen of the drawing application 201. FIG. 8 illustrates an example of the print setting screen of the drawing application 201. A screen 801 is the print setting screen of the drawing application 201 that the drawing application 201 displays on the display unit 119. The screen 801 includes objects 802 to 807. The control (object) 802 is a control item capable of specifying a print queue that is the printing destination from a list of print queues registered in the OS 214, including virtual queues. In FIG. 8, the control 802 is illustrated expanded. The control 802 specifies “Layout App” that is the virtual queue (also referred to as “virtual printer” or “virtual device”) corresponding to the application 213. The drawing application 201 acquires the PC 1701 generated based on the PDC 401 corresponding to the virtual queue currently selected by the control 802. The print setting screen 801 of the drawing application 201 is configured so that the user can specify the functions described in the PC 1701 and printing can be performed using the user-specified functions. The control (object) 803 is a control item capable of specifying the sheet size, for example. If a virtual queue is selected, the sheet size refers to an image size based on the drawing data to be included in the print data to be generated. Aside from A4, sheet sizes such as A5 and B5 can be selected. The control (object) 804 is a control item capable of selecting which to perform, color printing or monochrome printing. Options described in the PC 1701 can thus be selected using the controls 803 and 804. The button (object) 805 is a button that can issue an instruction to execute printing when pressed by the user using the pointing device 117. The button (object) 806 is a button for causing the screen 801 to transition to a data editing screen of the drawing application 201 when pressed by the user using the pointing device 117. The image (object) 807 is an image of the document or drawing generated on the data editing screen of the drawing application 201, laid out on a sheet selected using the control 803. An object indicating the page being displayed and objects for switching the page to be displayed are located below the image 807. The acceptance of the print instruction by the drawing application 201 in step P701 is equivalent to accepting the user's pressing of the button 805. The print setting screen illustrated in FIG. 8 is merely an example, and controls other than illustrated in the diagram and other elements may be displayed. If the print instruction from the user is accepted, the processing proceeds to step P702. In step P702, the drawing application 201 transmits a print instruction to the OS 214 with the image 807 as the image to be printed and the virtual queue of “Layout App” selected by the control 802 as the printing destination.

The issuance of the print instruction activates the skip control unit 206 of the extension application 204. The skip control unit 206 sets the print data generation software 202 so that the generation of print data by the print data generation software 202 is skipped.

If the print instruction is transmitted from the drawing application 201 to the OS 214, then in step P703, the OS 214 generates intermediate print data. Assuming that the print data generation software 202 is the IPP Class Driver as described above, the OS 214 generates data in XPS format as the intermediate print data. With the intermediate print data generated, the processing proceeds to print data generation instruction processing of step P704. In step P704, the OS 214 detects that the printing destination of the print instruction issued in step P702 is the virtual queue associated with the extension application 204, and transmits a print data generation instruction to the extension application 204 along with the intermediate print data.

The extension application 204 accepts the print data generation instruction from the OS 214, and starts the processing of step P705. In step P705, the print data editing unit 208 of the extension application 204 generates print data based on the intermedia print data received from the OS 214. The format of the print data varies depending on the application 213. The extension application 204 stores the file format to be used by the application 213 in advance. Here, the application 213 is assumed to be a layout editing application, and the format of the print data is XPS format that facilitates layout editing. If the application 213 is a document management application, the format of the print data may be PDF format. With the print data generation processing completed, in step P706, the print data editing unit 208 performs print data storage processing. To pass the print data to the application 213, the print data editing unit 208 here stores the print data in the area described by the information 1605 of the PDC 1601. The data that the print data editing unit 208 stores in the area described by the information 1605 in step P706 may include data other than the print data. For example, the print data editing unit 208 may generate a low-resolution bitmap image of the image to be printed, which is intended for the application 213 to display on the layout editing screen of the application 213, and store the low-resolution bitmap image. In step P706, the print data editing unit 208 stores such pieces of data to be used by the application 213 into the area described by the information 1605. After the completion of the processing of step P706, in step P707, the extension application 204 performs processing for launching the application 213. Specifically, the extension application 204 launches the application 213 by specifying the URI “LayoutAppLauncher:” using a URI launch-related API of the OS 214.

The application 213, when launched by the extension application 204, initially performs print data acquisition processing of step P708. In step P708, the application 213 refers to the information 1704 of the PC 1701 to determine the area where the print data is stored, and acquires the print data stored in the area. Since the print data is temporarily stored in the area, the application 213 deletes the data stored in the area once the print data is acquired. Here, the extension application 204 may inform the application 213 of the print data storage area using a parameter when launching the application 213. In such a case, the application 213 determines the print data storage area based on the launch parameter. In doing so, the extension application 204 may include the filename of the print data in the launch parameter of the application 213.

After the application 213 is launched and the print data is acquired, in step P709, the application 213 starts accepting data editing instructions. Since the application 213 is a layout editing application, the acceptance of data editing instructions refers to processing for accepting user operations to lay out images to be edited on the layout editing screen of the application 213. If the application 213 is a document management application, the acceptance of data editing instructions may refer to processing for accepting user operations to determine the filenames and classification of acquired data and determine which area of the application 213 to store the data in. In other words, the acceptance of data editing instructions in step P709 can be any processing for accepting user operations in line with the primary use of the application 213. Up to this point, the processes by which the application 213 acquires the data instructed to be printed to the virtual queue have been described. The virtual print queue to which the standard print data generation software 202 bundled with the OS 214 is assigned is thus combined with the extension application 204. This enables the application 213 to acquire various types of data in a predetermined format.

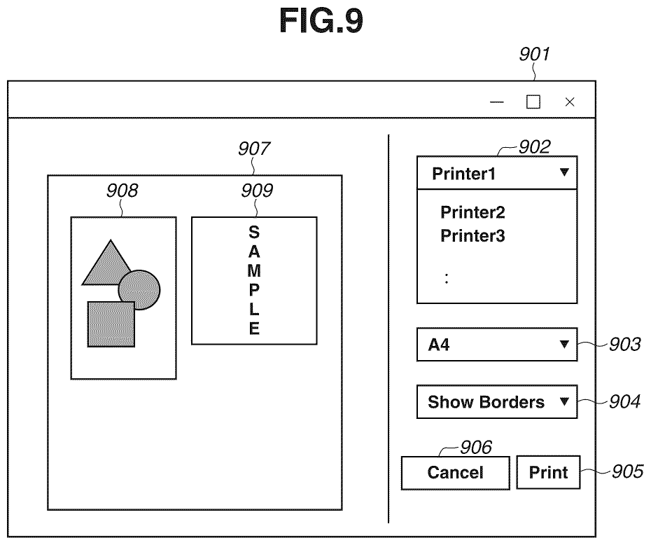

Processes related to the printing from the application 213 will be described. In step P710, the application 213 accepts a print execution instruction from the user on the print setting screen of the application 213. The print setting screen of the application 213 will be described with reference to FIG. 9. A screen 901 is the print setting screen of the application 213. The screen 901 includes objects 902 to 909. A control 902 is a control item capable of specifying a print queue that is the printing destination from a list of print queues that are registered in the OS 214, including virtual queues, and from which some print queues are excluded. Examples of some print queues include the virtual queue of the application 213. The application 213 thus enables selection of a print queue from the print queues registered in the OS 214, using the control 902. Suppose that “Printer1” in FIG. 9 refers to the printing apparatus 102. The application 213 can acquire the PC 1401 generated based on the PDC 301 corresponding to the print queue currently selected by the control 902. The print setting screen 901 of the application 213 is configured so that the user can specify the functions described in the PC 1401 and printing can be performed using the user-specified functions. For example, a control 903 is a control item capable of setting the size of sheets to be printed. Sheet sizes described in the information 302 of the PDC 301 corresponding to the printing apparatus 102 can thus be selected using the control 903. A control 904 is a control item capable of selecting whether to display borders of images to be laid out and reflect the borders on the print outcome. If “show borders” is selected using the control 904, borders surrounding an object 908 and an object 909 to be laid out are displayed, and the borders are actually printed as well. A button 905 is a print button that can issue a print execution instruction when pressed by the user using the pointing device 117. A button 906 is a cancel button for causing the screen 901 to transition to the layout editing screen of the application 213 when pressed by the user using the pointing device 117. An object 907 is an object indicating an image where the product obtained by the user laying out images to be laid out on the layout editing screen of the application 213 is laid out on a sheet of the size selected by the control 903. The user can check the image to be printed on an actual sheet by observing the object 907. An object 908 is an object representing the image file of the object 807 output from the drawing application 201 by the processing of steps P701 to P707. An object 909 is an object representing a document file output from a not-illustrated word processing application. In the present exemplary embodiment, the application 213 is launched when a print instruction is issued from the drawing application 201 with the virtual queue selected. In the state where the application 213 is running, the user issues a print instruction from a drawing application 201 with the virtual queue selected. Here, the running application 213 acquires the print data generated based on the print instruction and displays the print data. In such a manner, the single application 213 can acquire print data output from a plurality of drawing applications 201. The objects 908 and 909 are laid out as illustrated in the object 907 by the processing of step P709 for accepting user operations on the layout editing screen of the application 213. The acceptance of the print execution instruction in the subsequent step P710 refers to accepting the user's pressing of the button 905. The print setting screen illustrated in FIG. 9 is merely an example. Controls other than illustrated in the diagram and other elements may be displayed. If the print execution instruction is accepted from the user, the processing proceeds to step P711. In step P711, the application 213 transmits a print instruction to the OS 214 with the object 907 as the image to be printed.

If the print instruction is transmitted from the application 213 to the OS 214, then in step P712, the OS 214 generates intermediate print data. Assuming that the print data generation software 202 is the IPP Class Driver as described above, the OS 214 generates data in XPS format as the intermediate print data. With the intermediate print data generated, the processing proceeds to print data generation instruction processing of step P713. The OS 214 detects that the printing destination of the print instruction issued in step P711 is the print queue corresponding to the printing apparatus 102, and transmits the print data generation instruction to the print data generation software 202 along with the intermediate print data.

The print data generation software 202 accepts the print data generation instruction from the OS 214 along with the intermediate print data, and in step P714, performs print data generation processing. In step P714, the print data generation software 202 generates print data based on the intermediate print data received from the OS 214. The format of the print data is determined based on the information 1302 that the print data generation software 202 acquires from the printing apparatus 102. After the completion of the print data generation processing, the processing proceeds to step P715. In step P715, the print data generation software 202 transmits the generated print data to the printing apparatus 102. In step P716, the printing apparatus 102 receiving the print data from the print data generation software 202 performs print processing to print the print data on a sheet. Up to this point, the processes by which the data acquired by the application 213 is subjected to the user's editing operations and printed by the printing apparatus 102 have been described.

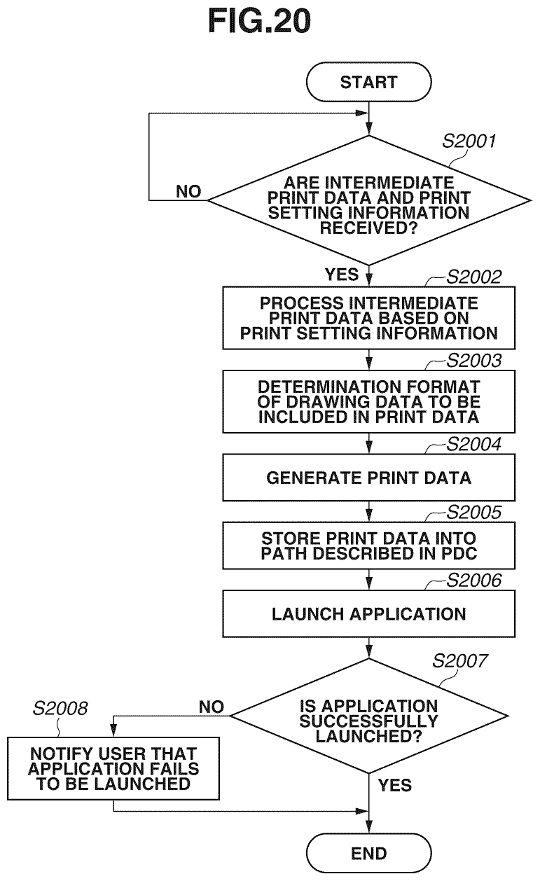

Now, details of the processing of the extension application 204 in steps P705 to P707 of FIG. 7A will be described with reference to FIG. 20. The processing illustrated in FIG. 20 is implemented by the CPU 111 executing a program provided by the extension application 204.

In step S2001, the CPU 111 determines whether intermediate print data and print setting information are received from the OS 214. While FIG. 20 illustrates the case of receiving the intermediate print data from the OS 214, the intermediate print data may be received from the print data generation software 202.

If intermediate print data or print setting information is not received (NO in step S2001), the processing returns to step S2001. If intermediate print data and print setting information are received (YES in step S2001), the processing proceeds to step S2002.

In step S2002, the CPU 111 processes the intermediate print data based on the print setting information. If an image addition function or a function of laying out a plurality of pages of images on a single page is enabled on the print setting screen provided by the drawing application 201, the CPU 111 edits the intermediate print data.

In step S2003, the CPU 111 determines the format of the drawing data to be included in the print data. The extension application 204 stores the format supported by the application 213 in advance. The CPU 111 calls the format stored in advance, and sets the format as that of the drawing data. In step S2003, the CPU 111 may access a predetermined external server and acquire the format of the drawing data supported by the application 213. In such a case, the extension application 204 does not need to store the format of drawing data supported by the application 213.

In step S2004, the CPU 111 converts the intermediate print data and the print setting information into drawing data and print setting attribute information, and generates print data.

In step S2005, the CPU 111 stores the generated print data into the path described by the information 1605 of the PDC 1601.

In step S2006, the CPU 111 launches the application 213. The CPU 111 launches the application 213 by specifying the URI “LayoutAppLauncher:” using the URI launch-related API of the OS 214.

In step S2007, the CPU 111 determines whether the application 213 is successfully launched. If the application 213 is successfully launched (YES in step S2007), the processing illustrated in FIG. 20 ends, and the extension application 204 is terminated. If the application 213 fails to be launched (NO in step S2007), the processing proceeds to step S2008.

In step S2008, the CPU 111 notifies the user that the application 213 fails to be launched. Here, the print data remains stored in the storage location of step S2005. The application 213 then automatically acquires the print data from the storage location and displays the print data when the user manually launches the application 213. Instead of the application 213 automatically displaying the drawing data included in the print data when launched, the print data may be read in response to issuance of the user's instruction to read the print data from the folder at the storage location.

In the present exemplary embodiment, if the application 213 fails to be launched, the CPU 111 notifies the user of the failure. However, step S2008 may be skipped without issuing the notification.

As described above, according to the first exemplary embodiment, the virtual print queue to which the standard print data generation software 202 bundled with the OS 214 is assigned and the extension application 204 are used in combination. This enables the application 213 to acquire various types of data in a predetermined format and print the data using the printing apparatus 102.

In the description of FIGS. 7A and 7B, an extension application 204 “corresponding to the printing apparatus 102” is not mentioned for the simplicity of description. In fact, an extension application 204 corresponding to the printing apparatus 102 may be installed on the OS 214. In such a case, the processing of steps P714 and P715 by the print data generation software 202 is performed by the extension application 204 corresponding to the printing apparatus 102.

In the present exemplary embodiment, the application 213 and the extension application 204 are described to be acquired through respective different procedures. However, the application 213 may be acquired with the extension application 204 included, and the extension application 204 may also be installed when the application 213 is installed.

The foregoing description has been given by using the layout editing application as an example of the application 213. However, the present exemplary embodiment is not intended to limit the type of the application 213. The application 213 may be other than the layout editing application. For example, as described above, the application 213 may be an application for a cloud print service. In such a case, the print instruction of step P711 is not issued to the OS 214 but transmitted to the not-illustrated cloud server. The print instruction of step P711 includes information specifying the image to be printed and the printing destination. The cloud server can thus identify the printing apparatus 102 from the printing destination information received from the application 213 for the cloud print service, and transmit the received image to be printed to the printing apparatus 102.

In the first exemplary embodiment, the extension application 204 is described to operate as an extension application dedicated to the application 213. If an application other than the application 213 also implements data output using a virtual queue, an extension application 204 dedicated to that application is used. In view of this, in a second exemplary embodiment, an extension application 204 includes a component to determine which of applications 213 and a printing apparatus 102 the printing destination is based on the name of the print queue. The second exemplary embodiment deals with a case where a single extension application 204 is operated as an extension application corresponding to a plurality of different applications 213 and the printing apparatus 102. Hereinafter, the configuration of the second exemplary embodiment shall be similar to that of the first exemplary embodiment unless otherwise specified.

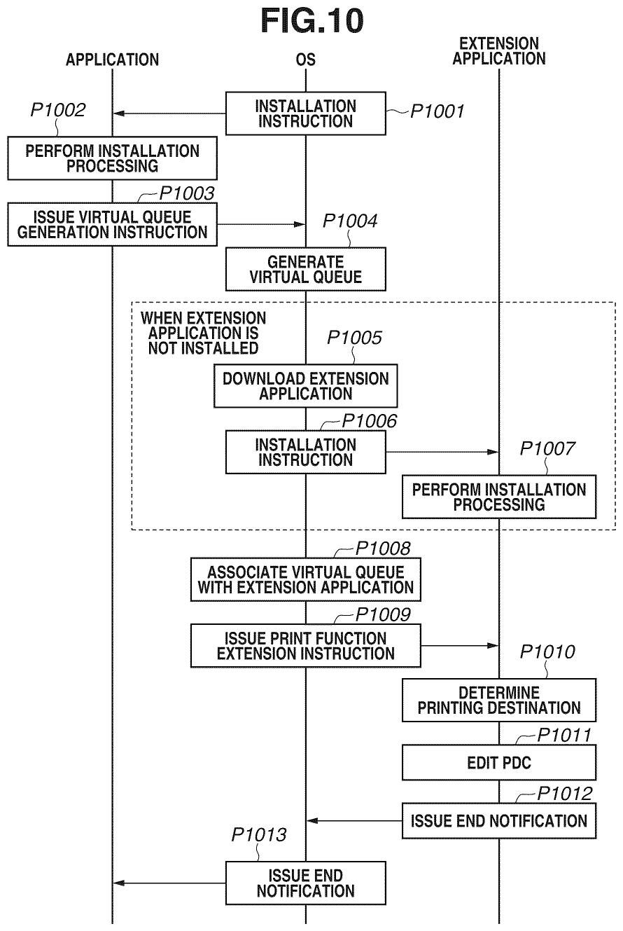

Processes during the installation of an application 213 according to the second exemplary embodiment will be described with reference to FIG. 10. FIG. 10 is a sequence diagram of the processes during the installation of the application 213. The processing of steps P1001 to P1009 is similar to that of steps P601 to P609. A description thereof will thus be omitted. In step P1009, the extension application 204 accepts a print function extension instruction from the OS 214. In step P1010, the extension application 204 performs processing for determining the printing destination. Specifically, the extension application 204 determines which of the applications 213 and the printing apparatus 102 the printing destination corresponding to the virtual queue is based on the model name of the virtual queue. The model name of the virtual queue can be acquired using the API of the OS 214.

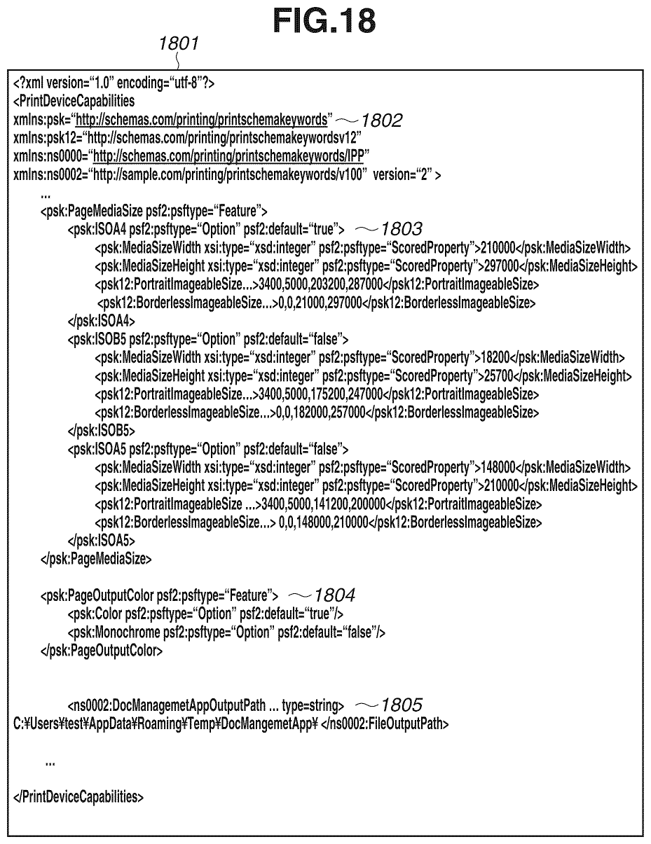

In the next step P1011, the print function extension unit 207 of the extension application 204 edits the PDC as the print function extension processing. Specifically, in step P1011, the print function extension unit 207 adds the area that is the print data output destination corresponding to the application 213, determined by the extension application 204 in step P1010, to the PDC 401. In the second exemplary embodiment, the print function extension unit 207 describes in the PDC 401 information that can identify the application 213 and information about the area that is the print data output destination of the application 213 in combination. FIG. 18 illustrates an example of the PDC 401 edited by the print function extension unit 207 in step P1011. FIG. 18 illustrates the example of the PDC 401 after two document management applications are installed as applications 213. Information 1801 is the example of the PDC 401 edited by the print function extension unit 207 in step P1011.

Information 1802 to 1804 is similar to the information 1602 to 1604. A description thereof will thus be omitted. Information 1805 is information that includes a character string describing the path of the area where the print data editing unit 208 of the extension application 204 outputs print data for each application 213. An attribute name that can identify the application 213 corresponding to the virtual queue is set as the information 1805. The extension application 204 can identify the application 213 associated with the virtual queue by referring to the information 1805. The information 1805 indicates that a document management application is used as the application 213 associated with the virtual queue. The subsequent character string “C:\Users\test\AppData\Roaming\Temp\DocMangemetApp\” describes the information about the area where the print data editing unit 208 outputs print data.

The OS 214 also issues a print function extension instruction to the print function extension unit 207 when the printing apparatus 102 is connected to the host computer 101. A description thereof will be omitted since FIG. 10 is a sequence diagram during the installation of the application 213. The print function extension unit 207 can edit the PDC 401 based on the capability information about the printing apparatus 102.

Specifically, the print function extension unit 207 may be configured to add features and options not included in the existing PDC 203 to the PDC 401, among the pieces of capability information acquired by the capability information acquisition unit 211. The functions for the print function extension unit 207 to add to the PDC 401 may be determined by other methods. For example, the print function extension unit 207 may determine the functions to be added to the PDC 401 based on information stored in the shared information 210 in advance.

When the print function extension processing of step P1011 is completed, the processing proceeds to step P1012. Steps P1012 and P1013 are similar to steps P611 and P612, and a description thereof will be omitted.

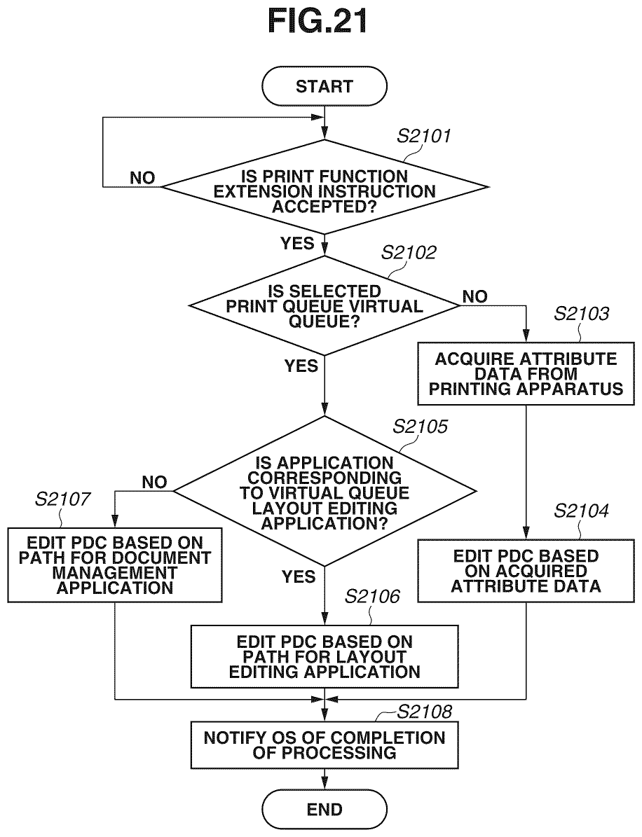

Details of the processing by the extension application 204 in steps P1010 to P1012 of FIG. 10 will now be described with reference to the flowchart of FIG. 21. The processing illustrated in the flowchart of FIG. 21 is implemented by the CPU 111 executing the program of the extension application 204.

In step S2101, the CPU 111 determines whether a print function extension instruction is accepted from the OS 214. If the print function extension instruction is not accepted (NO in step S2101), the processing returns to step S2101. If the print function extension instruction is accepted (YES in step S2101), the CPU 111 activates the print function extension unit 207 of the extension application 204 and the processing proceeds to step S2102.

In step S2102, the CPU 111 determines whether the selected print queue is a virtual queue. If the name of the print queue is one corresponding to the application 213 stored in advance, the CPU 111 determines that the print queue is a virtual queue. If the selected print queue is not a virtual queue (NO in step S2102), the processing proceeds to step S2103.

If the selected print queue is a virtual queue (YES in step S2102), the processing proceeds to step S2105.

If the selected print queue is not a virtual queue, or equivalently, the selected print queue is a print queue for transmitting print data to the printing apparatus 102, then in step S2103, the CPU 111 acquires attribute data from the printing apparatus 102. The CPU 111 performs the processing for acquiring the attribute data by using the Get-Printer-Attributes operation defined in the IPP.

In step S2104, the CPU 111 edits the PDC based on the attribute data acquired from the printing apparatus 102. Here, the CPU 111 can update the PDC based on attribute data that is unable to be handled by the print data generation software 202 alone.

Next, the case where the selected print queue is a virtual queue will be described.

In step S2105, the CPU 111 determines whether the application 213 corresponding to the selected virtual queue is a layout editing application. The CPU 111 makes the determination of step S2105 based on the model name of the virtual queue. If the application 213 corresponding to the virtual queue is a layout editing application (YES in step S2105), the processing proceeds to step S2106. In step S2106, the CPU 111 reads the path of the print data storage location for the layout editing application stored in the extension application 204, and edits the PDC. If the application 213 corresponding to the virtual queue is not a layout editing application (NO in step S2105), the processing proceeds to step S2107. In step S2107, the CPU 111 reads the path of the print data storage location for the document management application stored in the extension application 204, and edits the PDC.

While the extension application 204 is described to handle two applications 213, namely, the layout editing application and the document management application, the extension application 204 may handle three or more applications 213. Note that the host computer 101 is described to be connected to the actual printing apparatus (physical printer) 102 if the print queue is not a virtual queue. However, the print queue may be determined to not be a virtual queue in a case where the host computer 101 is connected to a cloud print service, in addition to the case where the host computer 101 is connected to the actual printing apparatus 102.

After the editing of the PDC, in step S2108, the CPU 111 notifies the OS 214 of the completion of the processing. Then, the processing illustrated in FIG. 21 ends.

In such a manner, the print function extension unit 207 determines the application 213, and describes the information about the area where the print data editing unit 208 outputs print data in the PDC 1801. This enables the application 213 to determine where the print data to be output to itself is stored by referring to not-illustrated PC when performing printing to be described below.

Since the same PDC 1801 separately describes different print data output destinations for the respective applications 213 in the same PDC 1801 as in the information 1805, a single extension application 204 can handle a plurality of different applications 213.

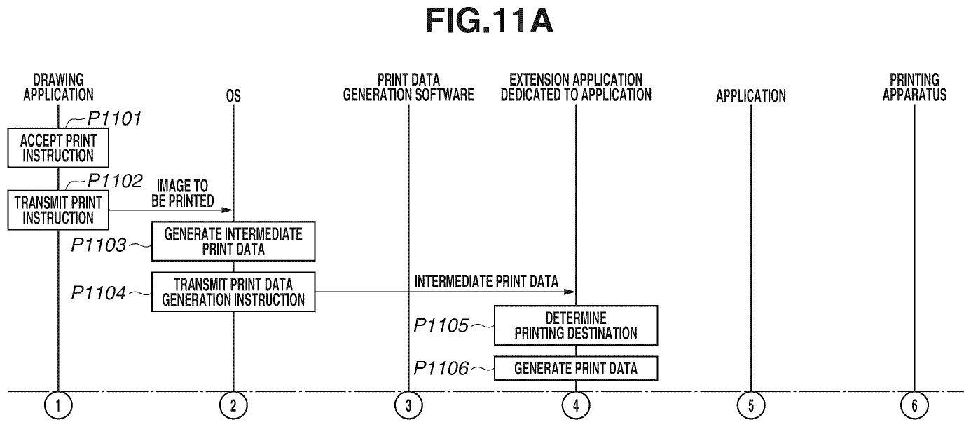

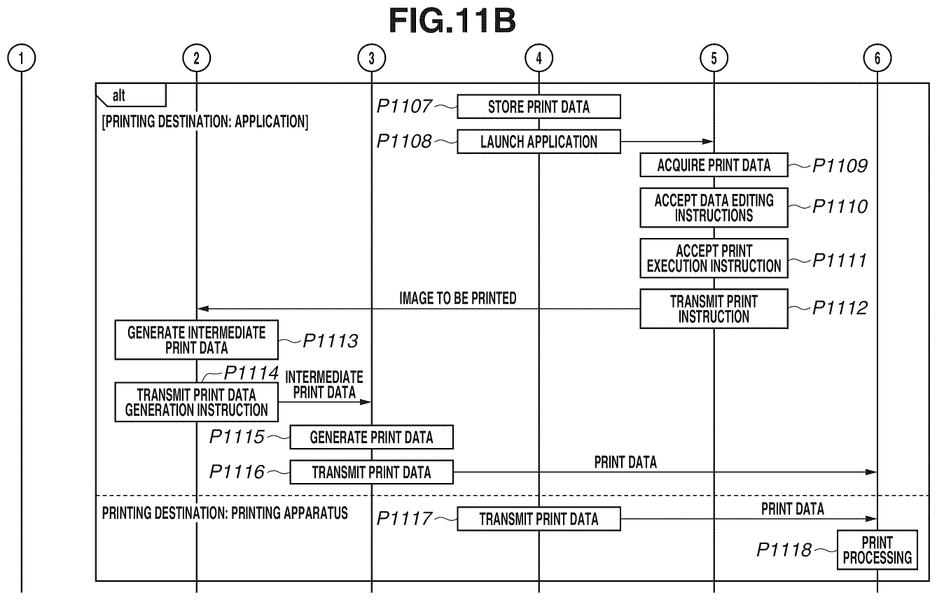

Next, the processes during the printing by the application 213 will be described with reference to FIGS. 11A and 11B. FIGS. 11A and 11B are sequence diagrams illustrating an example of the processes during the printing by the application 213. Steps P1101 to P1104 are similar to steps P701 to P704, and a description thereof will be omitted. In step P1104, the extension application 204 accepts the print data generation instruction from the OS 214. In step P1105, the extension application 204 performs processing for determining the printing destination of the print queue for which the print instruction is accepted. Details of the processing for determining the printing destination are similar to those of step P1010. In the next step P1106, the print data editing unit 208 of the extension application 204 performs print data generation processing. In the second exemplary embodiment, the print data editing unit 208 switches details of the processing depending on the printing destination determined by the extension application 204 in step P1105. For example, if the application 213 is a layout editing application, the print data editing unit 208 generates print data in XPS format. For example, if the application 213 is a document management application, the print data editing unit 208 generates print data in PDF format. If the printing destination is the printing apparatus 102, the print data editing unit 208 generates print data interpretable by the printing apparatus 102 (such as Printer Working Group [PWG]-Raster data and PDF data). If the printing destination determined by the extension application 204 in step P1105 is the application 213, the processing proceeds to step P1107. In step P1107, the print data editing unit 208 stores the print data generated in step P1106 into the area described as the path of the output destination area of print data for each application 213 in the PDC 1801. Here, the print data editing unit 208 stores the print data into the area corresponding to the application 213 determined in step P1105. As in the first exemplary embodiment, the data that the print data editing unit 208 stores in the area described by the information 1805 in step P1107 may include data other than the print data.

After the completion of the processing of step P1107, the processing proceeds to step P1108. The processing of steps P1108 to P1116 is similar to that of steps P707 to P715. A description thereof will thus be omitted.

On the other hand, if the printing destination determined by the extension application 204 in step P1105 is the printing apparatus 102, the processing proceeds to step P1117. In step P1117, the print data editing unit 208 transmits the print data generated in step P1106 to the printing apparatus 102. In step P1118, the printing apparatus 102 receiving the print data in step P1116 or P1117 starts print processing on a print sheet.

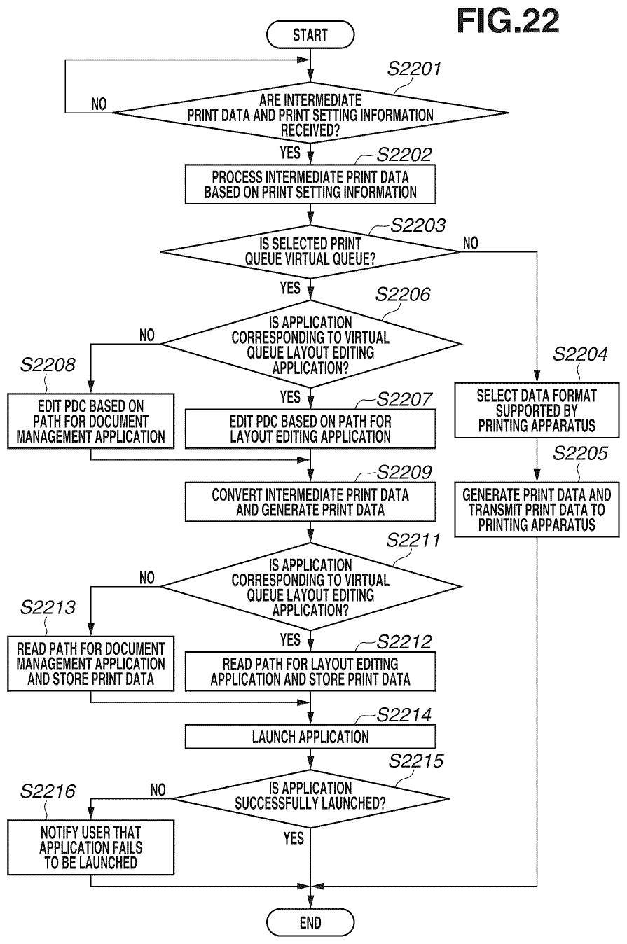

Details of the processing of steps P1105 to P1108 in FIGS. 11A and 11B will now be described with reference to FIG. 22. The processing illustrated in FIG. 22 is implemented by the CPU 111 executing a program provided by the extension application 204.

In step S2201, the CPU 111 determines whether intermediate print data and print setting information are received from the OS 214. If intermediate print data or print setting information is not received (NO in step S2201), the processing returns to step S2201. If intermediate print data and print setting information are received (YES in step S2201), the processing proceeds to step S2202. In the present exemplary embodiment, the intermediate print data and the print setting information are described to be received from the OS 214. However, such information may be received from the print data generation software 202.

In step S2202, the CPU 111 processes the intermediate print data based on the print setting information. The processing of step S2202 is similar to that of step S2002 in FIG. 20.

In step S2203, the CPU 111 determines whether the selected print queue is a virtual queue.

If the selected print queue is not a virtual queue (NO in step S2203), the processing proceeds to step S2204. In step S2204, the CPU 111 selects a data format supported by the printing apparatus 102 as the format of the drawing data. The CPU 111 refers to the PDC or PC corresponding to the printing apparatus 102, and sets the data format of the drawing data supported by the printing apparatus 102. Examples of the data format supported by the printing apparatus 102 include PWG-Raster format and PDF format. In step S2205, the CPU 111 generates print data in the format selected in step S2204, and transmits the print data to the printing apparatus 102. The CPU 111 generates and transmits the print data using the APIs provided by the OS 214.

If the selected print queue is a virtual queue (YES in step S2203), the processing proceeds to step S2206. In step S2206, the CPU 111 determines whether the application 213 corresponding to the virtual queue is a layout editing application. If the application 213 corresponding to the virtual queue is a layout editing application (YES in step S2206), the processing proceeds to step S2207. In step S2207, the CPU 111 selects the previously stored data format of the layout editing application. If the application 213 corresponding to the virtual queue is not a layout editing application (NO in step S2206), the processing proceeds to step S2208. In step S2208, the CPU 111 selects the previously stored data format of a document management application. In the present exemplary embodiment, the extension application 204 is described to store the data formats supported by the layout editing application and the document management application in advance. However, in steps S2207 and S2208, the CPU 111 may acquire the data format supported by the respective applications from an external server, and select the data format.

In step S2209, the CPU 111 converts the intermediate print data into drawing data of the format selected in step S2207 or S2208, and generates print data.

In step S2211, the CPU 111 determines whether the application 213 corresponding to the virtual queue is a layout editing application. If the application 213 corresponding to the virtual queue is a layout editing application (YES in step S2211), the processing proceeds to step S2212. In step S2212, the CPU 1111 reads the previously stored path for the layout editing application, and stores the generated print data. If the application 213 corresponding to the virtual queue is a document management application (NO in step S2211), the processing proceeds to step S2213. In step S2213, the CPU 111 reads the previously stored path for the document management application, and stores the print data.

In step S2214, the CPU 111 launches the application 213 associated with the virtual queue. The processing of step S2214 is similar to that of step S2006 in FIG. 20. In FIG. 22, not a fixed application but the application 213 corresponding to the selected virtual queue is launched.

In step S2215, the CPU 111 determines whether the application 213 is successfully launched. If the application 213 is successfully launched (YES in step S2215), the processing illustrated in FIG. 22 ends. If the application 213 fails to be launched (NO in step S2215), the processing proceeds to step S2216. In step S2216, the CPU 111 notifies the user of the error indicating that the application 213 fails to be launched.

In the second exemplary embodiment, the print data editing unit 208 thus switches the print data generation processing and the print data output destination based on the printing destination determined by the extension application 204. According to the second exemplary embodiment, a single extension application 204 can perform suitable processing on each of the plurality of different applications 213 and the printing apparatus 102.

The printing destination determination processing of step P1105 may use a determination method different from the foregoing. For example, the print setting screen extension unit 205 of the extension application 204 may be configured so that the user can specify the application 213 to be the transmission destination of the print data.

In such a case, the application 213 can be set as the printing destination based on the foregoing setting even if the printing apparatus 102 is selected as the transmission destination of the print data by the printing destination determination processing of step P1105. Here, the generated print data is stored in the print data storage area for the application 213 and not transmitted to the printing apparatus 102.

Up to this point, the second exemplary embodiment has demonstrated that a single extension application 204 can be operated to cope with a plurality of different applications 213 and the printing apparatus 102.

In the first exemplary embodiment, the extension application 204 is configured to directly launch the application 213 in step P707. A third exemplary embodiment deals with a configuration where the application 213 detects the storage of print data and automatically launches itself without the extension application 204 directly launching the application 213. Hereinafter, the configuration of the third exemplary embodiment shall be similar to that of the first exemplary embodiment unless otherwise specified.

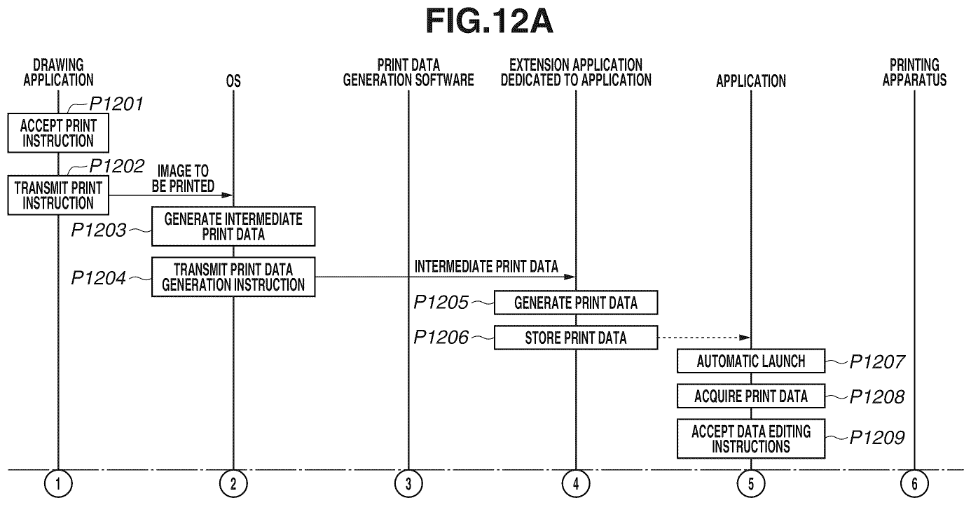

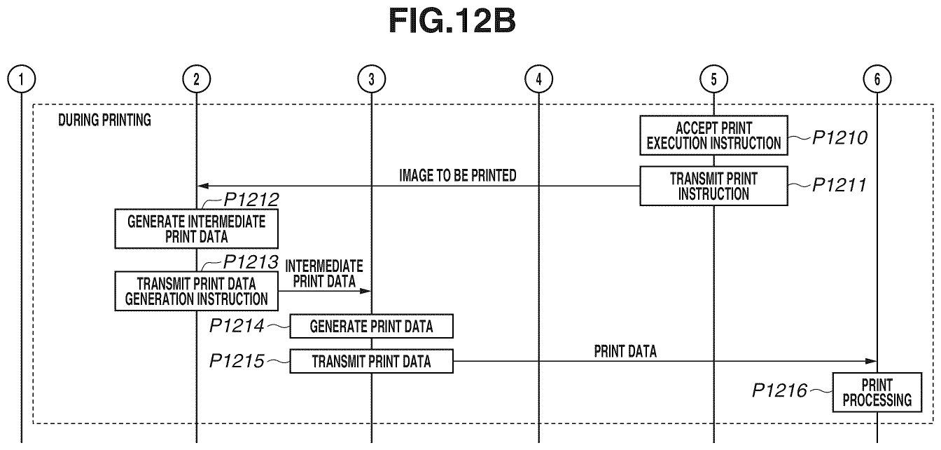

FIGS. 12A and 12B are sequence diagrams illustrating an example of processes during printing by the application 213 according to the third exemplary embodiment. Steps P1201 to P1206 are similar to steps P701 to P706, and a description thereof will be omitted. In the third exemplary embodiment, after the print data editing unit 208 of the extension application 204 stores the print data in the area described in the information 1605 in step P1206, the extension application 204 does not launch the application 213. Instead, the application 213 constantly monitors the storage of print data into the area described in the information 1605. When the storage of print data is detected, then in step P1207, the application 213 performs processing for launching itself. Specifically, a sub module of the application 213 is constantly running on the OS 214, and checks the area described in the information 1605 for data at predetermined intervals (for example, once in every two seconds). If the presence of data in the area described in the information 1605 is detected, the sub module of the application 213 launches the main module of the application 213. The application 213 launched by the sub module enters the processing of step P1208. The processing of steps P1208 to P1216 is similar to that of steps P708 to P716. A description thereof will thus be omitted.

As described above, in the third exemplary embodiment, the application 213 is configured to detect the storage of print data and automatically launch itself. This enables the application 213 to acquire the print data stored in the predetermined area by the print data editing unit 208 even if the launching method of the application 213 is unknown to the extension application 204. An example of the case where the launching method of the application 213 is unknown to the extension application 204 is where the URI of the launching module of the application 213 is unknown.

According to an exemplary embodiment of the present disclosure, a generic printer driver can be used even without an actual printing apparatus being connected.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-189827, filed Nov. 7, 2023, which is hereby incorporated by reference herein in its entirety.

What is claimed is:

1. A non-transitory computer-readable storage medium storing an application program which causes an information processing apparatus to perform a control method, the information processing apparatus having printing software, the control method comprising:
receiving an image processing setting;
storing data to which image processing corresponding to the image processing setting is applied into a predetermined storage area of the information processing apparatus in response to acceptance of an instruction to perform processing in a state where a virtual printer for which data is set to be generated using the printing software is selected; and
transmitting the data to which the image processing corresponding to the image processing setting is applied to a physical printer for which data is set to be generated using the printing software in response to acceptance of an instruction to perform processing in a state where the physical printer is selected as a printing destination,
wherein the printing software is configured to output data printable by a plurality of printing apparatuses of a plurality of different manufacturers to one printing apparatus based on an Internet Printing Protocol (IPP), the one printing apparatus being selected by a user from the plurality of printing apparatuses.

2. The non-transitory computer-readable storage medium according to claim 1, wherein the virtual printer is generated in response to installation of the application program.

3. The non-transitory computer-readable storage medium according to claim 1, the control method further comprising notifying an operating system of the information processing apparatus of a file path where capability information about image processing setting to be set for the virtual printer is stored.

4. The non-transitory computer-readable storage medium according to claim 3, wherein the application program includes a file storing the capability information.

5. The non-transitory computer-readable storage medium according to claim 1, wherein the printing software is a class driver provided by a supplier of an operating system of the information processing apparatus.

6. The non-transitory computer-readable storage medium according to claim 1, wherein the data to which the image processing is applied is Portable Document Format (PDF) data.

7. A control method of an information processing apparatus, the information processing apparatus having printing software, the control method comprising:
receiving image processing setting;
storing data to which image processing corresponding to the image processing setting is applied into a predetermined storage area of the information processing apparatus in response to acceptance of an instruction to perform processing in a state where a virtual printer for which data is set to be generated using the printing software is selected; and
transmitting the data to which the image processing corresponding to the image processing setting is applied to a physical printer for which data is set to be generated using the printing software in response to acceptance of an instruction to perform processing in a state where the physical printer is selected as a printing destination,
wherein the printing software is configured to output data printable by a plurality of printing apparatuses of a plurality of different manufacturers to one printing apparatus based on an IPP, the one printing apparatus being selected by a user from the plurality of printing apparatuses.

8. The control method according to claim 7, wherein the virtual printer is generated in response to installation of an application program.

9. The control method according to claim 7, further comprising notifying an operating system of the information processing apparatus of a file path where capability information related to image processing setting to be set for the virtual printer is stored.

10. The control method according to claim 9, wherein an application program includes a file storing the capability information.

11. The control method according to claim 7, wherein the printing software is a class driver provided by a supplier of an operating system of the information processing apparatus.

12. The control method according to claim 7, wherein the data to which the image processing is applied is PDF data.

13. An information processing apparatus that has printing software, the information processing apparatus comprising at least one processor operating to:
receive an image processing setting;
store data to which image processing corresponding to the image processing setting is applied into a predetermined storage area of the information processing apparatus in response to acceptance of an instruction to perform processing in a state where a virtual printer for which data is set to be generated using the printing software is selected; and
transmit the data to which the image processing corresponding to the image processing setting is applied to a physical printer for which data is set to be generated using the printing software in response to acceptance of an instruction to perform processing in a state where the physical printer is selected as a printing destination,
wherein the printing software is configured to output data printable by a plurality of printing apparatuses of a plurality of different manufacturers to one printing apparatus based on an IPP, the one printing apparatus being selected by a user from the plurality of printing apparatuses.
